(19) United States
(12) Patent Application Publication
(10) Pub. No.: US 2015/0379879 A1
(43) Pub. Date: Dec. 31, 2015

(54) SYSTEM AND METHOD FOR ASSESSING READER ACTIVITY

(71) Applicant: PARLOR LABS, INC., NewYork, NY (US)

(72) Inventors: Alexander G. Selkirk, Brooklyn, NY (US); Yue Yin, Brooklyn, NY (US); Anthony Gibbon, Renton, WA (US)

(21) Appl. No.: 14/764,978

(22) PCT Filed: Jan. 31, 2014
(86) PCT No.: PCT/US14/14305

§ 371 Date: Jul. 30, 2015

Related U.S. Application Data
(60) Provisional application No. 61/759,980, filed on Feb. 1, 2013.

(51) Int. Cl. G09B 5/06

(52) U.S. Cl. CPC G09B 5/06

(57) ABSTRACT

A system and method are provided for assessing user engagement with content viewed on a display of a computing device. The system analyzes user interactions with content, where the user can annotate the content with predetermined sentiments associated with the content being viewed. The annotations are responses, each of which may be associated with a particular type of predefined metadata. The system may then aggregate the annotations for each selection of content and render those annotations on the display within the content. Any user viewing the content can then view the annotations in order to stimulate further interaction with the system, e.g., via additional responses to the annotations.

### CROSS-REFERENCE TO RELATED APPLICATION(S)

This application claims priority to U.S. Provisional Application No. 61/759,980, entitled “SYSTEM AND METHOD FOR ASSESSING READER ACTIVITY,” filed Feb. 1, 2013, the contents of which are incorporated herein in their entirety.

### BACKGROUND

Engagement levels of students in a classroom environment vary drastically due to subject matter, teaching styles, student type, and many other factors. In larger classroom settings, such as online or seminar-type settings, determining student engagement level becomes even more of a challenge to instructors, as personal interaction with each student decreases and standard grading systems may not accurately reflect student knowledge. Standard assessment methods in wide use today are inadequate tools for measuring student mastery of subject matter.

For example, at higher education levels, students often have fewer opportunities to demonstrate their ability to learn and their knowledge on a given subject as fewer exams are administered and their marks or grades depend solely on those exams. Judiciously, in most of today's higher education institutions instructors are typically responsible for grading exams and papers from hundreds of students. As such, they provide data points that are too few and far between to yield an accurate granular picture of day-to-day student progress

Consequently, when a student fails an exam, that student often has little opportunity to improve a final grade and/or provide proof of personal progress or knowledge of the subject. If that student fails to grasp concepts in the subject matter taught in the class or has difficulty engaging in the subject matter, the instructor may also be completely unaware until grading the student's exam.

### BRIEF DESCRIPTION OF THE DRAWINGS

FIG. 1 is a diagram of a suitable environment in which a reading assessment system or micro-reading response system operates.

FIG. 2 is a block diagram of a server computer capable of implementing the micro-reading response system in FIG. 1.

FIG. 3 is a flow diagram of the micro-reading response system.

FIG. 4 is a flow chart of a method performed by the micro-reading response system for analyzing reader activity on a client computer.

FIG. 5 is a flow chart of a method performed by the micro-reading response system for performing a peer review on an annotation by a user.

FIG. 6 is an example of a screenshot of a user interface displayed initially on a client computer for selecting user preferences in the micro-reading response system.

FIG. 7A is an example of a screenshot of a user interface displaying reading content being selected and annotated with sentiments by a user.

FIG. 7B is another example of a screenshot of a user interface displaying reading content being selected and annotated with sentiments by a user in an additional embodiment.

FIG. 7C is an example of a screenshot of a user interface displaying reading content being selected and annotated with themes by a user.

FIG. 7D is an example of a screenshot of a user interface displaying previously annotated reading content being selected and annotated by a user.

FIG. 7E is another example of a screenshot of a user interface displaying previously annotated reading content being selected and annotated by a user.

FIG. 7F is an example of a screenshot of a user interface displaying previously annotated reading content including annotation marks along the body of the content.

FIG. 7G is an example of a screenshot of a user interface displaying a micro-reading response box for answering a pop quiz in response to annotation made by a user.

FIG. 8 is an example of a screenshot of a user interface displaying previously annotated video content being viewed and annotated by a user.

FIG. 9A is an example of a screenshot of a user interface displaying content-related discussion feeds and summarized metrics associated with a particular subject matter.

FIG. 9B is another example of a screenshot of a user interface displaying various nuggets corresponding to content-related discussion feeds associated with a particular subject matter, aggregated and arranged based on metadata such as user activity.

FIG. 9C is an example of a screenshot of a user interface displaying an expanded view of an article nugget in FIG. 9B and its associated metadata.

FIG. 9D is another example of a screenshot of a user interface displaying various nuggets in content-related discussion feeds associated with a particular user

FIG. 9E is an example of an article nugget found in content-related discussion feeds.

FIG. 9F is another example of an article nugget found in content-related discussion feeds.

FIG. 9G is an example of a screenshot of a user interface displaying response nuggets found in content-related discussion feeds which correspond to a particular date.

FIG. 9H is an example of a screenshot of a user interface displaying long read nuggets found in content-related discussion feeds which correspond to a particular date.

FIG. 9I is an example of a screenshot of a user interface displaying a saved nugget found in content-related discussion feeds.

FIG. 9J is an example of a screenshot of a user interface displaying a nugget associated with a particular theme found in content-related discussion feeds.

FIG. 10A is an example of a screenshot of a user interface displaying a user-specific aggregation of topics read by both the user and various other users, such as other users in the same class.

FIG. 10B is an example of a screenshot of a user interface displaying a user-specific aggregation of concepts that students have tied to annotations in the content read by both the user and various other users.

FIG. 11 is an example of a screenshot of a user interface displaying a user-specific aggregation of websites read by both the user and various other users.

FIG. 12 is an example of a screenshot of a user interface displaying a user-specific aggregation of annotations by the sentiment applied and related content read by the user and other users in the class.

FIG. 13 is an example of a screenshot of a user interface displaying various metrics and aggregate lists of inputs for multiple users.

FIG. 14 is an example of a screenshot of a user interface displaying a graphical representation of various levels of user interaction, such as response activity and content viewing activity.

FIG. 15 is an example of a screenshot of a user interface displaying an implicit peer review nugget in a user feed.

FIG. 16 is an example of a screenshot of a user interface displaying an explicit peer review nugget in a user feed.

FIG. 17 is an example of a screenshot of a user interface displaying a topic cloud identifying a profile topic pair for a user.

FIG. 18 is an example of a screenshot of a user interface on a mobile device displaying a long read nugget found in content-related discussion feeds.

FIG. 19 is an example of a screenshot of a user interface on a mobile device displaying an annotated nugget found in content-related discussion feeds.

### DETAILED DESCRIPTION

A system implemented through a client software program is provided. The system analyzes user interaction with content being viewed on a display and/or listened to on a device in order to facilitate learning in an academic environment.

The system utilizes content associated with a first user, such as an instructor, and displays that content and/or related content to a second user, such as a student. For example, the content can be written material (e.g., a reading assignment), a video (e.g., a news report), or an audio clip, such as a radio clip. The content can be found in literature, audio or videos (e.g., YouTube) which can be accessed via the Internet or another content provider. The instructor can additionally enter concepts and themes related to, e.g., the reading assignment, or other suggested and/or related reading, videos, audio clips, etc., which the student will later be able to identify while viewing the content along with their sentiments about the content being viewed. Identifying the themes is just one form of user interaction that can be recorded and analyzed by a micro-reading response system. (While the invention is often discussed with respect to viewing content such as reading an article, it applies equally to watching a video clip or listening to an audio clip.)

A user's interaction is analyzed through various inputs based on, for example, time spent viewing a selection of content, annotations to the content and continuance in viewing content having related subject matter. For example, a user can annotate a page of content displayed on a client computer by selecting a passage, or excerpt from the content. The assessment system automatically generates a comment or micro-reading response box, which is displayed to the user, and allows the user to enter a predefined sentiment regarding the passage and associate that sentiment and passage with a predefined theme for a particular subject matter, e.g., Physical Science. The sentiments can be characterized by metadata associated with a predefined type of sentiment. A sentiment meta-type, which is a characterization of the sentiment by type, is used by the system to analyze the micro-response provided by the user. In some embodiments, the micro-reading responses for a particular selection of content can provide summarized overview or consensus of the sentiments via indicators, e.g., ticks, along the length of the content.

Each of the aforementioned inputs is recorded by a server in real-time while the content is displayed to the user to read via, e.g., a browser window. The input data is sent to the micro-reading response system for analysis in order to provide the user with visual metrics of the statistics regarding, for example, that user's reading versus other users readings. Additionally, the user can be provided with related topics, individualized feeds, and, in some instances, comments in response to the user's annotations on that particular content.

The micro-reading response system can also extrapolate information related to the content, such as metadata, keywords, topics, names, annotations, etc. and utilize that information to relate content read by multiple users within the system. The information can also be utilized to suggest the related content to those users in feeds as well as in user-specific recommendations provided in visual metrics representing aggregate engagement activities of other users. The metrics can be displayed within the content being viewed, such as color-coded underlines or color-coded comments in a feed being displayed with the content.

The micro-reading response system provides an environment in which users can assess their own learning habits and improve them, based on several different factors such as, time management per content, annotation of the content and amount of content viewed, as well as similar data from other students that the system makes available to the class. For example, the system can graphically represent the other student's response within the content being viewed by a user via graphically displayed pointers or tick marks along the length of the content (e.g., body of text or video timeline) and/or within the content itself, such as with underlines or quotations in the content e.g., text of an article. Additionally, the system can provide, for example, instructors with an overview of which content is not favored by a group of students, which students are not viewing the content and which students are struggling to learn and understand the content. Certain user interactions with the system can also generate discussions on the content, which can be provided within a user feed viewable when the user access the system.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

### I. System Environment

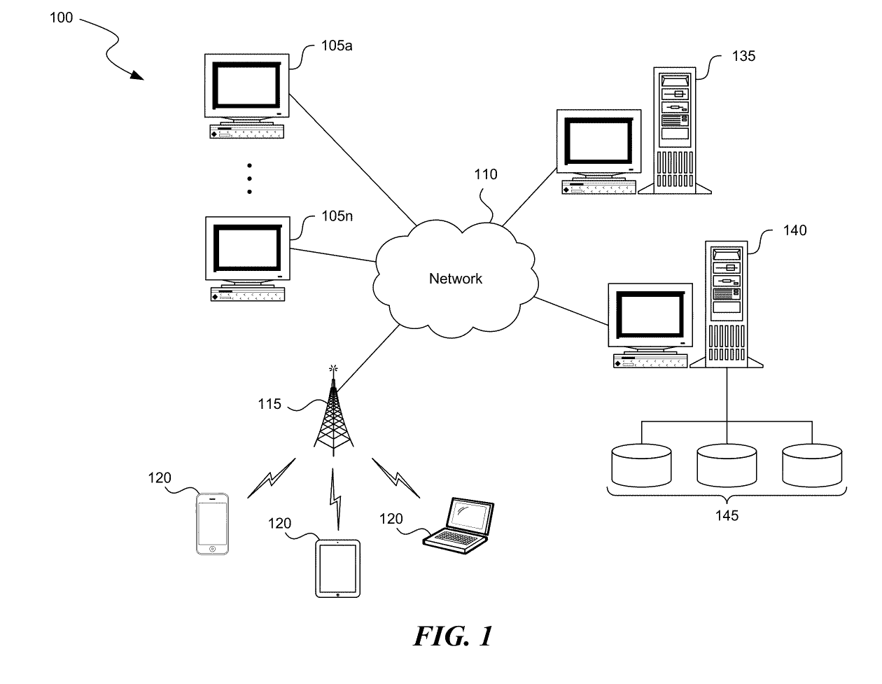

FIG. 1 and the following discussion provide a brief, general description of a suitable computing environment 100 in which a micro-reading response system is implemented.

Although not required, aspects and implementations of the invention will be described in the general context of computer-executable instructions, such as routines executed by a client computer, e.g., a personal computer or tablet, smartphone, etc., and a server computer. Those skilled in the relevant art will appreciate that the invention can be practiced with other computer system configurations, including Internet appliances, laptops, netbooks, tablets, multiprocessor systems, microprocessor-based systems, minicomputers, mainframe computers, or the like. The invention can be embodied in a special purpose computer or data processor that is specifically programmed, configured, or constructed to perform one or more of the computer-executable instructions explained in detail below. Indeed, the terms “computer” and “computing device,” as used generally herein, refer to devices that have a processor and non-transitory memory, like any of the above devices, as well as any data processor or any device capable of communicating with a network, including consumer electronic goods or other electronics having a data processor and other components, e.g., network communication circuitry. Data processors include programmable general-purpose or special-purpose microprocessors, programmable controllers, application-specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical-based disks, flash memory devices, or any other type of non-volatile storage medium or non-transitory medium for data. Software may include one or more program modules, which include routines, programs, objects, components, data structures, and so on that perform particular tasks or implement particular abstract data types.

The invention can be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described below may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring now to FIG. 1, a micro-reading response system 100 operates between one or more computing devices, such as mobile devices 120, client computers 105a-n, and servers 135, 140. The micro-reading response system can be accessible through a network, such as through the Internet, via a software plug-in that is downloaded on a client computer and accessed via browser, such as FireFox, Google, or Safari. For example, a user can log into a client computer 105a, such as a personal computer, and access the micro-reading response system server computer 140 through the network 110. The user can download the software plug-in from the server computer 140 for the micro-reading response system. The plug-in can be visibly displayed, for example, in the toolbar of the browser window and can be accessed anytime that the user is utilizing that browser. A similar communication can occur through mobile devices 120, the base station 115, network 110, and micro-reading response server computer 140. On some mobile devices, the software is displayed as an application, which can be selected and run prior to the user viewing any reading content.

The mobile devices 120, client computers 105a-n, and server computers 135, 140, each include an interface enabling communication with the network 110. The mobile devices 120, client computers 105a-n, appliance 112, and television 113 communicate via the network 140 with a server 115.

One or more data storage devices 145 are coupled to the micro-reading response system server computer 140 for storing data and software necessary to perform functions of the system. For example, data storage devices 145 can include a database of clients and client profiles, client activity data, a database of content related data, and a database of feed related information. The databases may additionally include or be associated with the application software needed to analyze content for metadata or software for assessing the data inputs related to the user reading activity.

In some embodiments, the micro-reading response system communicates with one or more third party servers 135 through the network 110. Third party servers 135 can provide services and data to the micro-reading response system, such as content metadata, additional content requested by users of the system (e.g., via a paid content system) or other information required for the micro-reading response system to function in a desired manner. In some embodiments, the third party service provider provides analysis software for the interaction data collected by the micro-reading response system.

The mobile devices 120, 125, 130, client computers 105a-n, the reading assessment server 140 and third party server 135 communicate through the network 110, including, for example, the Internet. The mobile devices 105, 125, 130 communicate wirelessly with a base station or access point 115 using a wireless mobile telephone standard, such as the Global System for Mobile Communications (GSM, or later variants such as 3G or 4G), or another wireless standard, such as IEEE 802.11. The base station or access point 115 communicates with the micro-reading response server 140 and third party server 135 via the network 110. The client computers 105a-n, communicate through the networks 110 using, for example, TCP/IP protocols.

### II. System

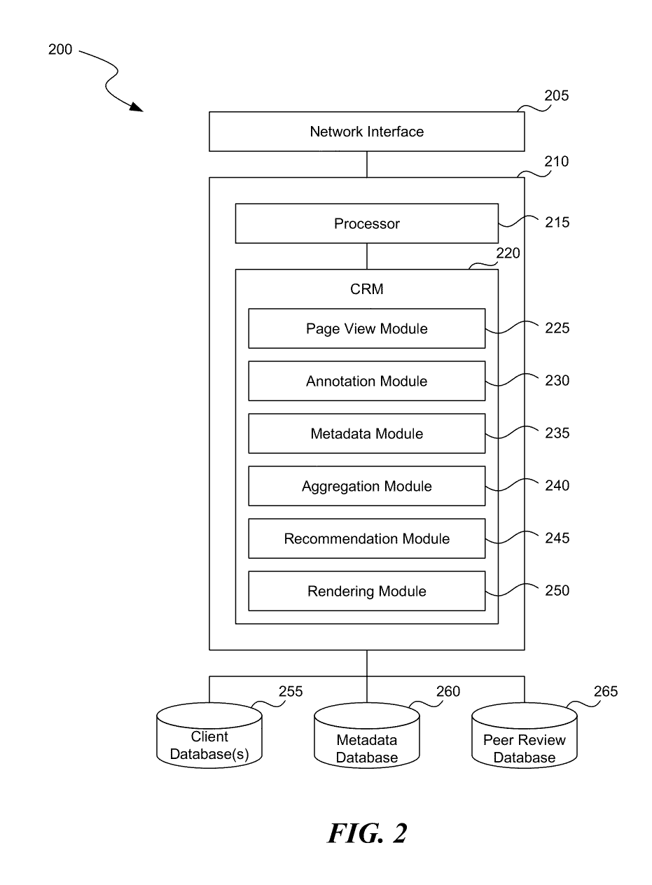

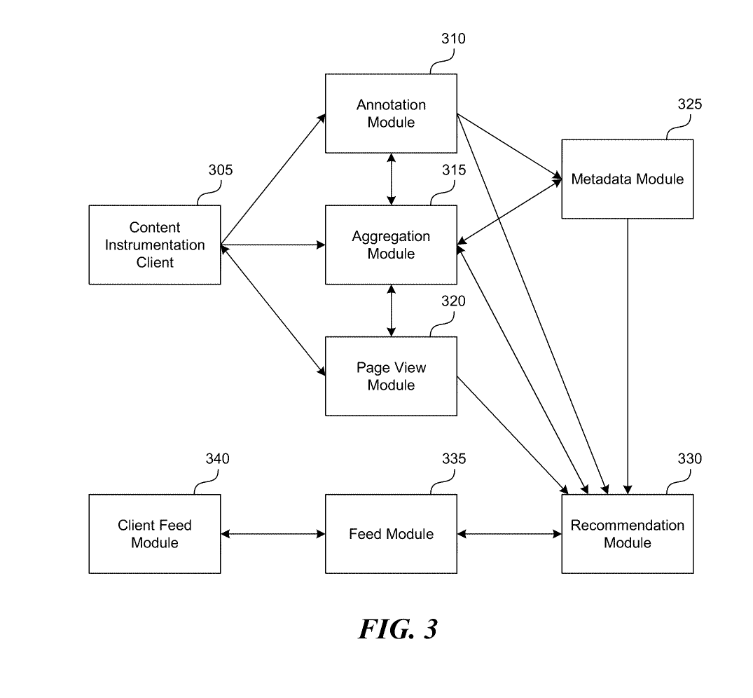

The micro-reading response system is now described with reference to FIG. 2 and FIG. 3.

FIG. 2 is a block diagram of a server computer 200 including the various components of the micro-reading response system. The micro-reading response system can be accessed through the network via client software, such as a plugin to a network browser. Data collection for a user can be performed through the plugin and sent to the server computer 200 for analysis. Multiple plugins can be made available dependent on client type. For example, a client computer can have a different plugin than a smartphone. Some plugins can offer different system visibility and functionality to the end-user. For example, a plugin for a Smartphone may not provide as many visual metrics or feedback to a user as a client computer. However, the user's data can be collected in a similar manner and input into the system via the server computer 200 through a wireless network connection.

The plugin can also enable tools utilized by the user while viewing content, such as the annotation tools allowing a user to select specific text or video segment and assign annotations to that selection. The plugin can additionally communicate on the backend with the server computer 200 to determine if any data is known in the system about the particular content being viewed. For example, a user can be reading an article X, which was previously read by another user in the system. The article X may be assigned identifier ‘12345’ in the system and may have annotations, metadata and other related data associated with it that are visually provided through the plugin to the user. If article X is not known in the system, the aggregation module, described in detail below, will retrieve any information associated with it.

The components on the server computer 200 are represented by modules, each of which provides a specific function in the micro-reading response system. The server computer 200 is coupled to the network via a network interface 205, such as a wireless or hard-wired interface as described with reference to FIG. 1. The server computer includes at least one processor 215, which communicates with the computer-readable medium 220 on which the computer-executable code including instructions for performing each function of the modules is stored. The computer-readable medium 220 can include any form or combination of memory, or storage medium, as described in FIG. 1, such as a EEPROM, EEPROM, RAM, ROM, DRAM, DDRAM, or the like. Different modules may be stored on different types of memory, depending on the function they provide.

A page view module 225, as shown in FIG. 2, receives the data collected by the client software, or plugin, e.g., through a browser, and distributes the data to various other components within the micro-reading response system. The data can arrive in reports for each user during each session that the user is logged into the micro-reading response system and viewing content. The data can describe the different characteristics of engagement for a user. For example, the data can include the amount of time the user spent viewing each page of the content, the annotations made to the content (and when those annotations were made), the amount of content (e.g., number of pages, a word count, or length of video), the type of content (e.g., video, audio or text), the location of the content, when the content was viewed, etc. Any number or types of measurements can be taken for the inputs for a specific user and/or client-type.

An annotation module 230 receives all data related to micro-reading responses to the content, or annotations, made by each user. The annotations can include both predefined sentiments expressed about a specific passage in a content being read as well as associated themes or concepts selected by the user for that passage. The annotations additionally include elaborations of the predefined sentiments and themes selected by a user. The annotation data collected by the annotation module can be related to audiovisual (e.g., streamed or recorded video) content as well as visual (e.g., still images), audio (e.g., mp3 or wave file), and/or textual (e.g., magazine article). The annotations module 230 also handles all the annotation threads related to specific content. For example, the annotation module 230 can receive an annotation on content identified as ‘12345’ being viewed by a user and associate that annotation with both the content and the user and then relay that information to other components in the system.

The metadata analysis module 235 analyzes the content being viewed by a user in order to extrapolate various identifying features of the content. For example, the metadata analysis module 235 can determine keywords to describe the content, identify key individuals named in the content, and resolve key concepts of the content based on the terminology in the content. The metadata analysis module 235 can further assign a number to each piece of content processed and send the metadata associated with that content to a metadata database 260 coupled to the server computer 200. The metadata can then be retrieved each time the content is viewed by a user and identified by the system.

The aggregation module 240 aggregates all of the information known by the system about a particular piece of content in order to generate various feedback to the user on the client computer. For example, the metadata, annotations, related articles, related concepts, feeds, and other information which may be available for a specific content, are stored and associated with that content on the aggregation module 240. For example, when a user begins to read article ‘12345’, all the associated information stored within the system is provided for that article to the user.

The recommendation module 245 collects all of the information pertaining to a particular user and generates recommendations for that user. For example, the recommendation module 245, collect annotations made by a user, content viewed by a user, metadata in the content viewed, the user engagement inputs (such as time spent on viewing the content), the number and/or types of different content items viewed, etc. The recommendation module 245 generates recommendations to a user based on the information received from the system and input by the user. The recommendations can include, for example, other annotations to review, recommended content related to content already viewed by that user, etc.

The server computer can include a memory for storing data accessed and the processes run by each module. Additionally, the server computer can be coupled to any number of databases on which user information and content related information is stored. For example, the server computer 200 can be coupled to a client database 255 which stores information related to each client accessing the system, such as user profile data or particular course data. The server computer 200 can also be coupled to a metadata database 260, a peer review database 265, a sentiments database (not shown), or another database for storing data associated with the system. The metadata database 260 may include identification data related to content already viewed by users in the system such as keywords associated with the content as well as annotations added to the content and themes associated with the content. The peer review database 265 may include comments, viewing statistics, and response data associated with each content and with each user. The peer review database 265 may additionally store data related to the feeds generated for display to each user and for each course. The sentiment database may store numerous sentiments associated with various educational levels of content viewed by users in the system as well as associated meta-types for each sentiment.

FIG. 3 provides a block diagram of the communication between each of the services provided by the modules in FIG. 2.

Referring now to FIG. 3, a client 305 is representative of the client computer on which the client software is installed and run to implement the micro-reading response system. The client 305 collects any data both input by the user while reading a specific content and additional data measured by client software and communicates that data to each of an annotation module 310, aggregation module 315 and page view module 320. The client 305 communicates unidirectionally with the annotation module 310 to forward any annotations to a specific content viewed by a user. The client 305 communicates unidirectionally with the page view module 320 to forward activity data regarding a specific user, such as time spent viewing a particular piece of content.

The client 305 communicates bidirectionally with the aggregation module 315 in order to determine if the content displayed to the user is known to the micro-reading response system and to retrieve any data related to that content from the system for display to the user. The aforementioned communication is performed in real-time such that the content displayed to the user may include annotated content. If a user has already created an annotation on a given portion of content (e.g., page of an article, clip from video report) or another portion of that content item, then the content will already be known to the system (including all associated metadata).

The annotation module 310 communicates with the aggregation module 315 to provide annotations on content in order for the aggregation module 315 to associate those annotations with that content.

The aggregation module 315 communicates with the metadata module 325 when content being read by a user has no associated data in the system, e.g., the content is being read for the first time. The aggregation module 315 send a request for metadata to associate with the content from the metadata module 325, such as topic, keywords, field, etc. The metadata module 325 generates the associated metadata and then sends that metadata back to the aggregation 315 module to provide to the user through the client interface 305.

The metadata module 325 also communicates the content metadata to the recommendation module 330 to associate with a particular user for later recommendation of content having related metadata.

The page view module 320 communicates reading activity data collected through the plugin to the aggregation module 215. The aggregation module 315 then associates that data with the content being read. For example, the number of users who read the content, the amount of time each user took to read the same content and other information can be associated with a particular article in order for visual metrics regarding the content to be generated and displayed for that user after reading the content.

The page view module 320 communicates with the recommendation module 330 in order to provide all of the reading activity measured through the plugin. The reading activity is associated with the user reading the content in order to determine user-specific recommendations and user-specific visual metrics about the user to the user and other users on the system. For example, the user took thirty (30) minutes to read article 12345, whereas the majority of other users took twenty (20) minutes the read article 12345. The user may be shown this information after reading the article.

The recommendation module 330 communicates with the feed generating module 335 to provide recommendations for each user's feed based on all of the data inputs regarding a specific user, such as the content read, metadata, annotations made, etc., that is processed into personalized data for that user in the recommendation module. The feed generating module then handles caching of data entered in the feed and responds to requests from the client for new recommendations and communicates those requests back to the recommendations module 330.

The feed generating module 335 communicates with feed client 340 to provide the recommendations for rendering in the client interface for display to the user.

### III. Methods

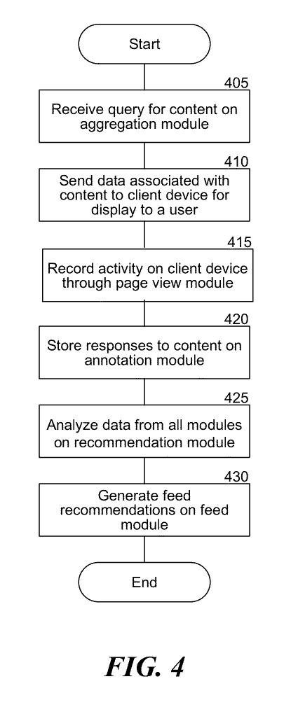

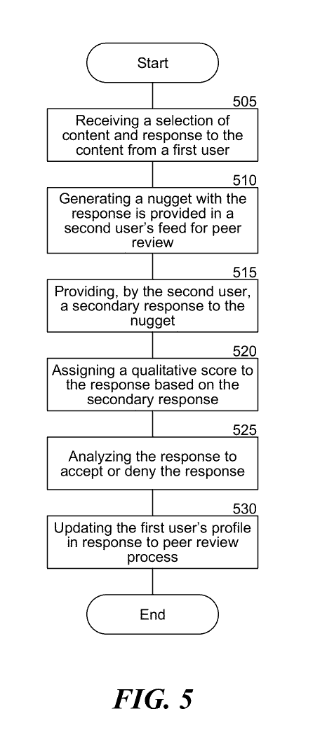

Methods for assessing user reading activity in the micro-reading response system are now described with reference to FIGS. 4-5.

Referring to FIG. 4, a flowchart of a method for assessing the reading activity of a user through a client plugin is illustrated. The method can be implemented on a server computer communicating with a client software application installed on a user's device, such as a personal computer, via a network.

In step 405, the micro-reading response system receives a query on the aggregation module. In some embodiments, the query includes the universal resource locator (URL) of the content being viewed. The system then attempts to match the URL to one stored in the system to identify the content. In other embodiments, the query can include reference to a specific content being visibly displayed on a screen of the user's device. For example, excerpts from the title or first line of text. The aggregation module can receive the query and compare the content (e.g., via a hash algorithm) to a database of known content on the system. For example, if the content was previously viewed by another user on the system, additional metadata regarding that content is stored on a database coupled to the system and an identifier is assigned to that specific content. If the content has not been viewed by a user on the system, the aggregation module can query another service, such as a third party service provider, to analyze the content and provide metadata for that content. Accordingly, through known content on the database or through another means, the aggregation module retrieves or accesses metadata on the content being displayed to the user.

In step 410, the aggregation module sends the content associated data to the client device through the network. The data can include metadata and other data associated with that content if known to the micro-reading response system. For example, if the content was previously read by another user who annotated that content, those annotations would be sent to the client device and displayed through the client plugin to the user.

In step 415, the page view module records activity on the user's interaction with the content, such as the time spent per page of content, any selection of content or themes or sentiments applied to the content, reading of related articles or other related content, and any additional activity necessary to the micro-reading response system. The user activity may be analyzed based on the interaction with the content and displayed in a visual metric to illustrate that user's progress, participation and knowledge of a particular material.

In step 420, any annotations made to the content are then mapped to the content and stored in the annotation module for later use. For example, the annotations mapped to a specific content can be called through the annotation module when another user views the same content or the content is recommended in a nugget, such as in a user's activity feed.

In step 425, the aggregate activity data collected through each of the annotation module, the page view module and the aggregation module about a specific user and piece of content is sent to the recommendation module for processing. The recommendation module determines which content and related data is displayed in the user's feed. Many factors in the user's content viewing history and activity related to specific content is also utilized by the recommendation engine to determine the nuggets of recommended content generated for that user feed, not solely the content being viewed, because it only provides one set of data to input into the user's profile for that user's feed associated with a specific class.

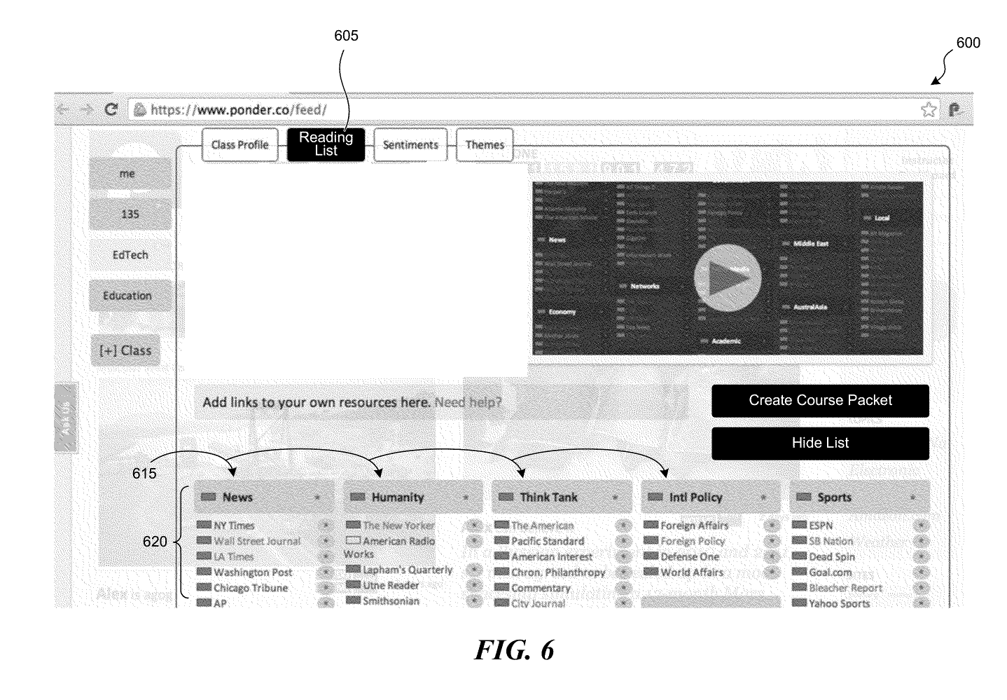

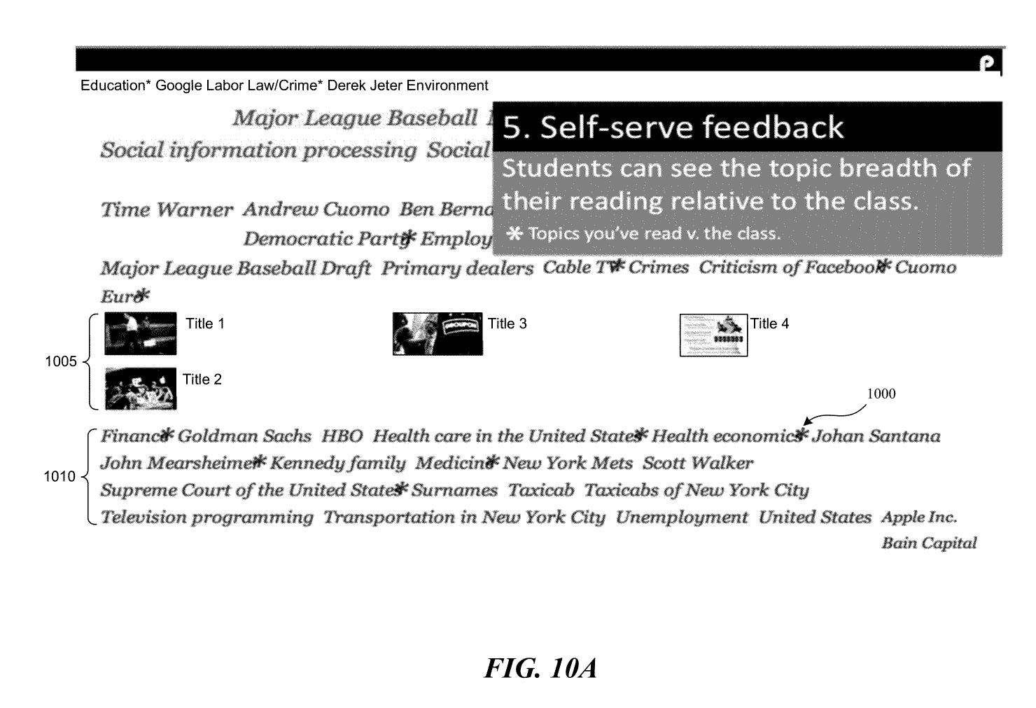

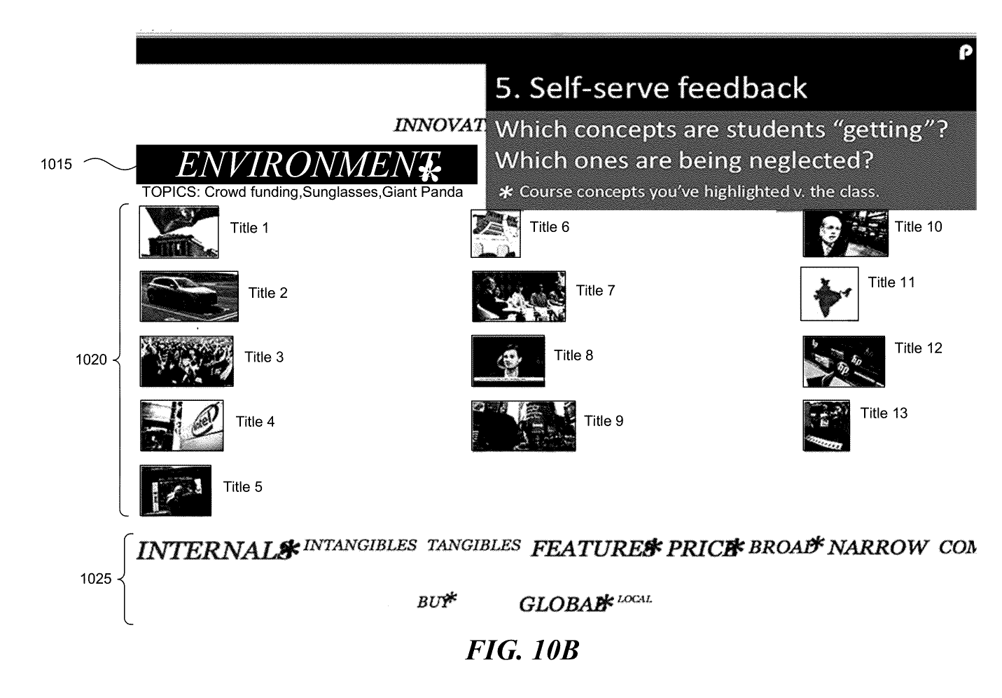

In step 430, the user's data feed is generated based on the recommendations from the recommendation module. The user's feed is rendered in the display of the user's client interface for viewing by the user. While viewing the generated feed, the user can select various nuggets, e.g. pieces of feed data related to specific content or category of content, and the user's activity with that feed nugget (described in detail below) can be recorded by the micro-reading response system in the same manner as the original content selected by the user at step 405. Accordingly, any user interactions with the micro-reading response system are utilized to formulate the user's profile and how any content in a feed is selected for that user as well as any other recommendations or statistical summaries of that user's activity, as is described with reference to FIGS. 10-14. In some embodiments, the user is provides with two separate views of the activity feed: a first feed view, is chronological with the most recent activity at the top; and the second feed view (denoted by a “!” label) is by usage, with the most active, controversial and interesting activity near the top and based on the system's recommendations. This is further illustrated in reference to FIG. 6.

Referring now to FIG. 5, a flowchart of a method for conducting a peer review of an annotation dependent on the various weights applied to users profiles is illustrated.

In step 505, a first user selects a passage from content and provides an annotation to that passage. Dependent on the user's profile, the annotation may be put through the peer review process or published immediately in or with that content for other users to review and respond to while reading. If the user is an expert in the topic and content which the annotation is made, the annotation can be published. However, if the user rarely views the content type being annotated or, for example, if the user is new to the micro-reading response system, the annotation may be peer reviewed prior to publishing that annotation for all the users in the class to review.

In step 510, one or more second users are provided with a nugget on a passage selected from content read by the first user. The nugget, such as for an article, includes an annotation from the first user in the class. The nugget is provided to a profile diverse set of second users in the class that, for example, either have an expressed interest in and/or knowledge of the subject matter to which the annotation made.

In step 515, the annotation receives user interaction, or activity, in response to the annotation. For example, the annotation receives a response annotation including a sentiment. The sentiment can be one of a specific set of predetermined sentiments utilized in the peer review process. In another example, the annotation can receive a response when a user reads the document, such as an article, to which the annotation is tied. The system tends to weight more heavily annotations from people who are experts in the area and to others who it might be relevant to and might be interested in it, but may not know much about it.

In step 520, the user who created the annotation receives a qualitative score from the one or more second users' interactions. The score from each one of the second users can be determined by that user's profile. For example, if a second user (e.g. an instructor) reviewing the annotation is an expert on the topic to which the annotation was applied or is an expert in the field of the content on which the annotation was made, the score for that second user interaction is weighted heavily. This indicates that the first user provided a good annotation.

In another example, a third user reviewing the annotation provides numerous interactions with the annotation, e.g., provides a response annotation and clicks on the article and agrees “me too” with the first user's annotation. However, the third user's profile shows that the third user has no knowledge or even interest in the field of the content or topic to which the annotation pertains. The third user's score is weighted lightly and may even be worth less qualitatively than a single interaction by the expert second user described in the previous paragraph.

In step 525, the annotation can be accepted and published in or with the content for users in the class to review or can be denied based on the score received during the peer review process. To determine this, the page view module, such as described in FIG. 3, can record all of the user interaction during the peer review process of the first user's annotation and can forward that data to the recommendation module for further qualitative analysis, such as the weighting of each interaction dependent on the user profile and whether certain thresholds were met during the peer or expert review process. The peer review process can occur over a predetermined time period or after a predetermined number of other class users have logged into the system and viewed their feeds including the nugget with the first user's annotation. Accordingly, each annotation in the peer review process can be provided with the same opportunity to be published and for the user's profile to be modified and weighted accordingly.

The peer/expert review process can also provide users with feedback in the form of recommendations. For example, the recommendation may be provided on how to improve their annotation skills, such as in a suggested annotation on the next content viewed by the user or an example of an annotation. Additionally, articles with related content or topics to read, may be provided in that user's feed.

In step 530, the first user's profile is updated according to the scores received on their annotation and in response to the content being read by that user. For example, when the first user receives highly weighted scores for their annotation during a peer review, this can also be reflected on the first user's profile for their knowledge in the area in which the annotation was made. Accordingly, the user's credibility score for that specific subject matter increases.

The user's profile has various levels of credibility, dependent on the subject matter, or topic area of a specific content, which can be categorized by the system by the content's associated metadata. When an annotation made by a user that is useful, or generates engagement (a lot of associated user activity) for a number of other “high credibility” users in that topic area, the annotation is weighted differently than an annotation that is useful or engaging likewise to “low credibility” users in the topic area. This is because the system recognizes that the annotation does a great job of leading a new reader to gain interest in a previously unknown topic area. The annotation is then deemed good, even if it may not be obvious to other “high credibility” user in the topic area. Accordingly, the system can mark the annotation, e.g., weight it more heavily. For example, a high credibility user annotates a specific piece of literature often taught in a higher level English Literature class. Then, multiple other high credibility users also annotate in response, but low credibility users, having no idea to what the annotation refers, skip the annotation and content altogether. The annotation can be weighted according to only that group of high credibility users and the system can determine that the annotation will most likely not generate any new interest or discussion across a range of users. The annotation is high credibility, topic-specific.

### IV. User Interface

Screenshots of the user interface (UI) are illustrated in the following three sections (IV-VI) with reference to FIGS. 6-15.

The micro-reading response system is initialized by a first user, such as an instructor, who pre-selects content to recommend to a group of other users, such as students. The instructor has an user interface similar to the student, but has additional visibility into each student profile and can select how students are grouped, e.g., by class. Additionally, the instructor can enter one or more predefined themes to which the recommended content corresponds and which will be viewable by a student during use of the system.

Once the instructor configures the class “settings” for a specified group of students, the instructor can send a hyper link or other instructions to each student's electronic mail (e-mail) address to access the micro-reading response system.

In order to register, a student can access the link and register with the system such that a profile is created on the reading assessment database for that student. The student can configure various settings, such as how much visibility and sharing is desired while using the micro-reading response system. Additionally, the student can view numerous different classes for which that user may be registered on the micro-reading response system. The various different user options will be described in the following section VI with reference to the user-specific feeds displayed in the user interface.

Referring now to FIG. 6, an initial screenshot of the user interface for a user to select various types of content is shown. For example, the user interface of FIG. 6 can be displayed to an instructor configuring a suggested reading set for a class of relevant sources and related material to that class. Instructors typically include a set of readings that are specific to the class that are, for example, assigned readings. However, in the micro-reading response system, the instructors can offer entire academic journals that may be relevant to the subject matter. Accordingly, not all the suggested content is necessarily assigned and required content. Some content may be, for example, recommended readings that are primarily for student discovery of which the micro-reading response system can track a student's selection. In some embodiments, the student can choose to nominate content for discussion in class whether or not that content was suggested by an instructor.

The instructor then can configure the course concepts or themes for the class. For example, the instructor can provide a syllabus covering a dozen or so different high-level concepts they want students to identify in the suggested content in order to feed discussion during class. The different concepts can be configured for each class and provided in an annotations tool box, which can be a pop out window displayed to the user each time a specific passage of content is highlighted by a student, or user of the micro-reading response system. Annotations to the content displayed on through the client are described in the following section V.

### V. Annotations

Annotations can include one or more words or short descriptions of a selected passage of content. Annotations can purvey a sentiment felt by the user and triggered by the selected passage of content. Annotations can also be linked to several predefined themes associated with the content which the user is reading. Annotations made by a user are recorded in the user's profile and assessment by the micro-reading response system to provide various recommended content to the user, to determine which nuggets are displayed in the user's feed and to provide the user with feedback and discussion with other users in the system.

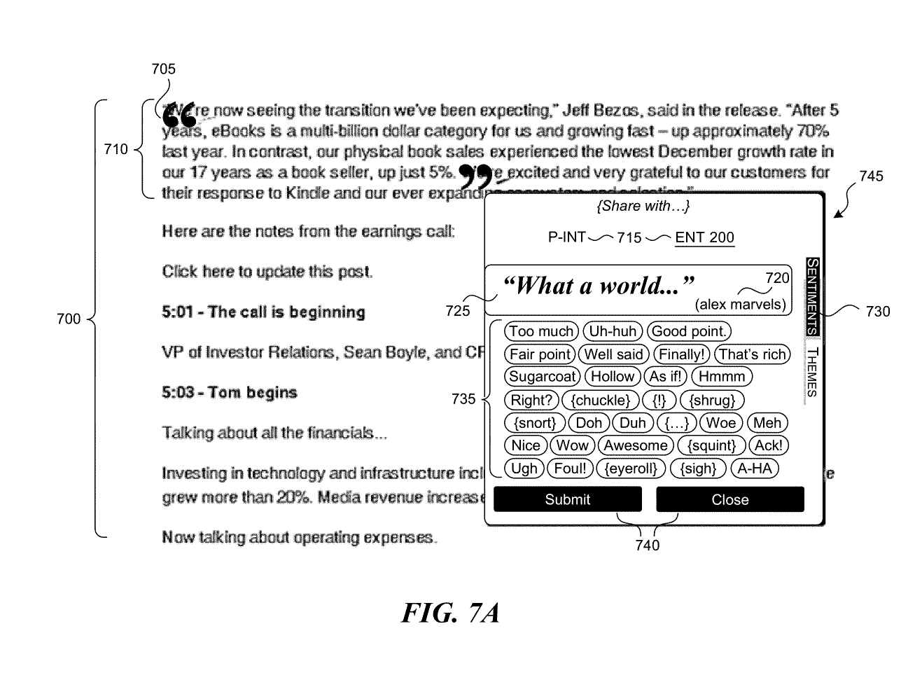

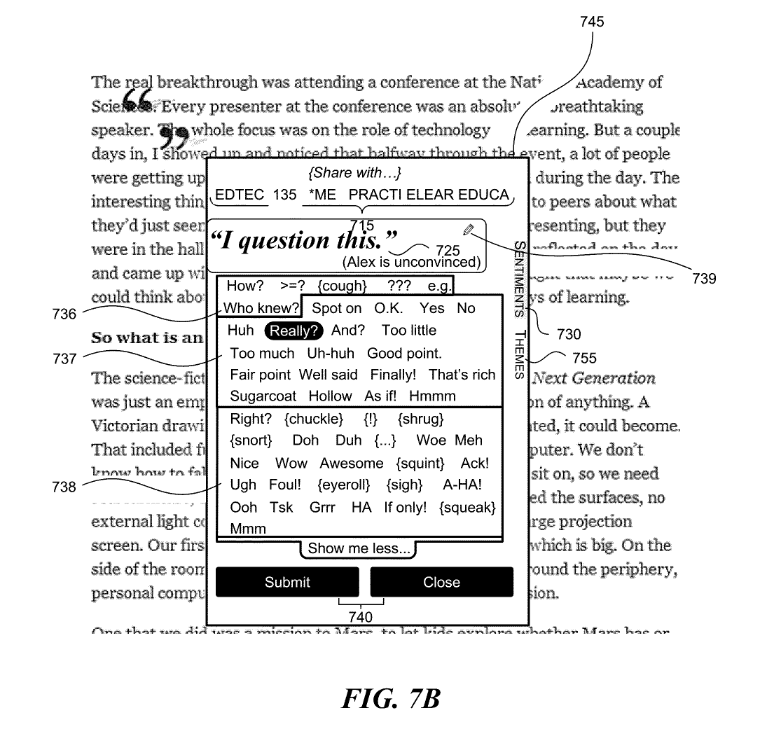

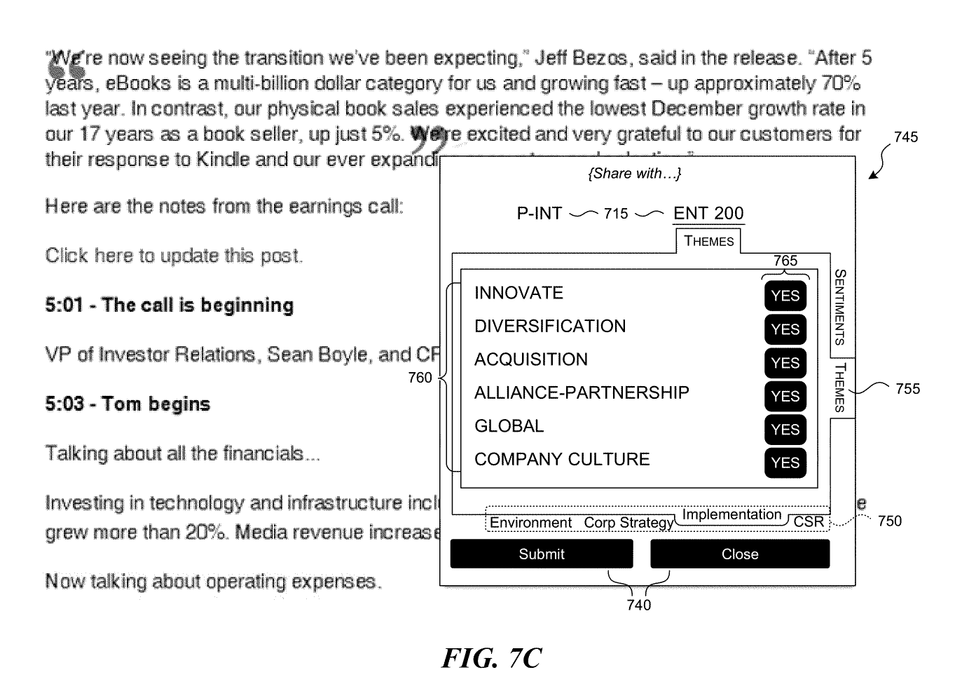

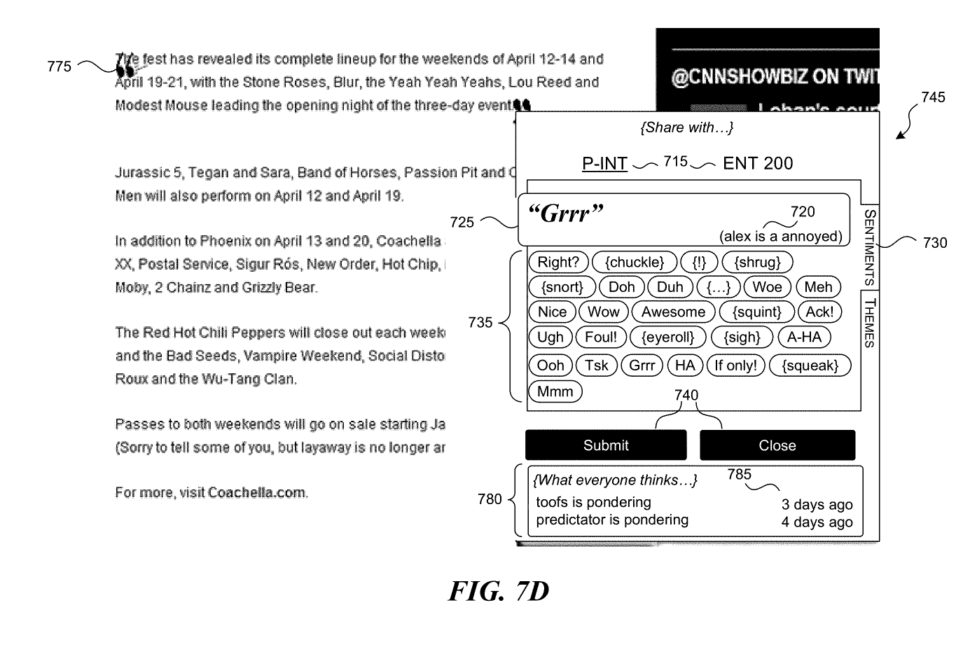

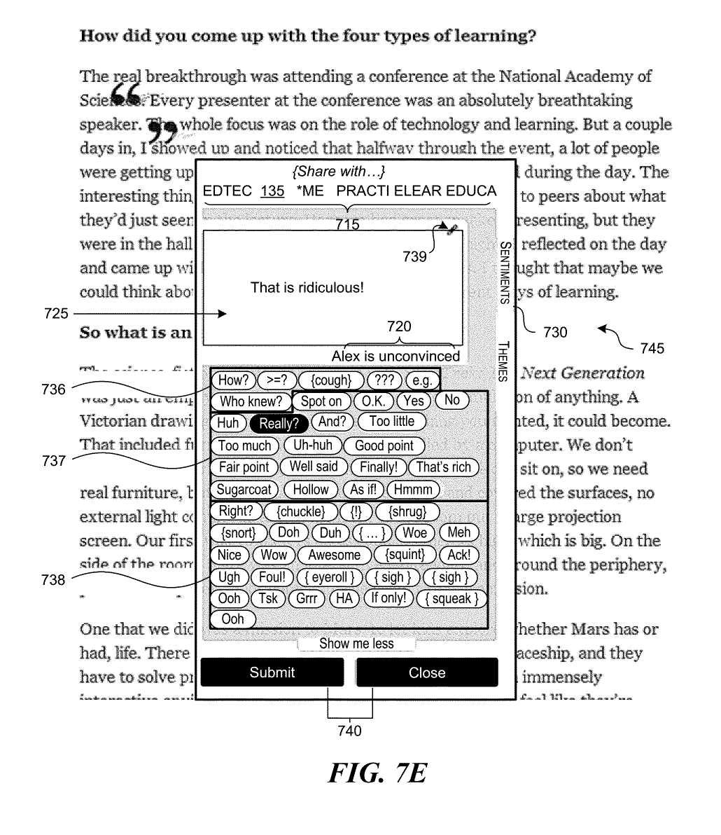

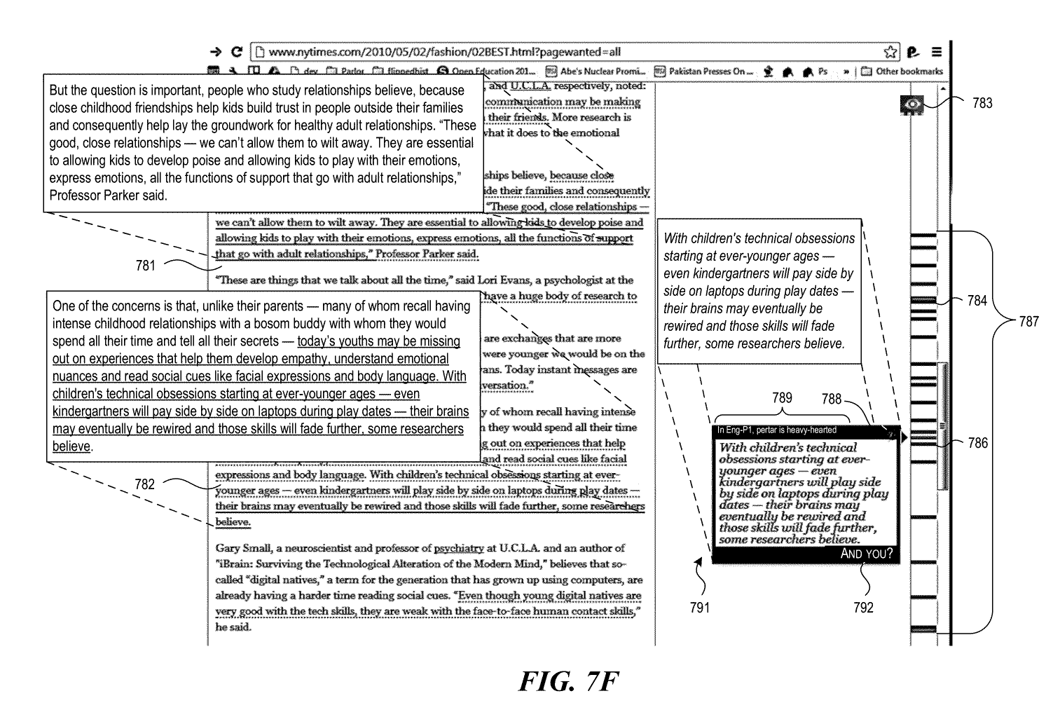

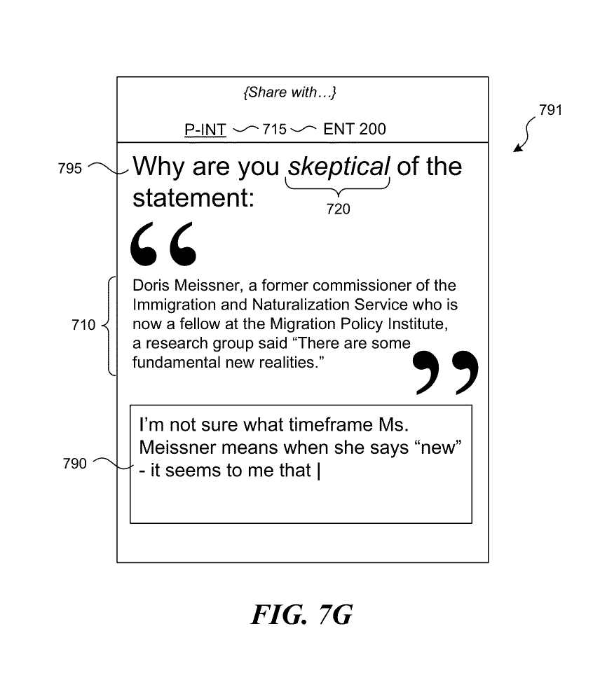

Referring now to FIG. 7A, an example of a screenshot of a page of content 700 is shown. For example, when a user is registered with the micro-reading response system and selects a recommended article to read for a class assignment, a portion of that content is displayed on the screen of the user's personal computer. The user may find a passage of the content interesting and choose to select a portion of that content via an input device, such as a mouse or keyboard coupled to the device on which the micro-reading response system client software is installed.

The user can select the passage 710, and quotations 705 or other identifying marks of a specific color or shade of color, e.g., lighter or darker, are displayed to the user to identify that the selection for annotation has been made. After selecting the content, the user may see a symbol pop up when hovering over the selected content, such as “P” for Ponder. If the user selects through clicking or entering an input selection on that symbol, a pop-up or micro-reading response box can appear to respond to the passage and complete the annotation. In some embodiments, if the student selects the content, the response box 745 automatically appears. When the response box 745 is called, it can initially be toggled to a sentiments tab 730 which displays a set of predefined sentiments 735 to the user.

The response box 745 can include various components. For example, the response box 745 can allow a user to select a class 715 for which the annotation should be made if that user is registered with more than one class on the micro-reading response system. The user can also be given a text box to include a free form sentiment that can be tied to one of a number of predefined sentiments 735 in the response box 745. As shown in FIG. 7A, a text box 725 provides a more descriptive expression, generated by the system, of the shorthand sentiments which the user can select in the response box 745. A preview 720 of how that user's sentiment will be displayed to other users reading the same content for which the annotation is being added is also provided in the text box 725. Numerous predefined sentiments 735 are provided, however each sentiment can be weighted differently, dependent on the type of sentiment expressed.

After making the selection of the class for which the sentiment is being made, the sentiments desired and/or adding additional free form sentiments in the text box, the user can then chose to save the annotation by selecting an input button 740, such as the “submit” button. The user can close the response box 745 with the “close” button, which allows the user to either close the response box after submitting an annotation or cancel submission of the annotation altogether. The user can select to close the annotation response box with only a sentiment or can additionally tie a course concept, or theme to the selected passage as well.

FIG. 7B illustrates another embodiment to that of FIG. 7A. As shown in FIG. 7B, the user is provided a pencil icon 739 which, when selected, allows a user to add free form textual comments to tie to the particular sentiment selected, e.g., to expand upon that sentiment. The full text box 725 (not shown) is illustrated and further discussed in reference to FIG. 7E. The user is also provided with a selection of coursework or group of users 715 to associate the annotation and/or theme, which can change the sentiments and/or themes displayed to the user under each of the sentiments tab 730 and the themes tab 755 in the response box 745. For example, as shown in FIG. 7B, additional sentiments are provided within the micro-reading response box 745. The additional sentiments may be provided based on the level of coursework being viewed by the user and/or dependent on the type of content being viewed by the user. For example, a 6 year old student may be provided a set of sentiments and a 17 year old student may be provided another set of sentiments. Similarly, a student analyzing a difficult piece of Applied Mathematics content may be provided a different set of sentiments than that student is provided while viewing a selection of English Literature. Likewise, the sentiments can be translated to different languages for use on texts of other languages, or for students with different levels of fluency.

The additional sentiments provided in FIG. 7B also are separated into groups 736, 737, 738, via the associated meta-type. For example, there can be three meta-types or meta-sentiments: comprehension or understanding, judgment or evaluation, and emotion or reaction. Each of the meta-type sentiments displayed in the response box 745 may be color-coded according to the meta-type group in which they are associated. For example, the sentiments expressed in a first group 736 may be associated with responses having to do with basic comprehension or incomprehension as the case may be in a reading passage such as, “What does this mean?” or “I'd like examples” or “I need a break down.” A second group 737 may be shown in an differing color and include responses that pass judgment through evaluation, such as “This is hyperbole” or “Oversimplification” or “Insight.” A third group 738 may be shown in yet another color and include responses that express some kind of emotional reaction, such as disapproval, regret, or admiration.

In some embodiments, the sentiments are not visually separated (e.g., via color-coding) during initial review of a selection of content in order to gauge user interaction without introducing additional inputs which may skew the user's response. However, the predefined meta-type for each sentiment shown in a micro-reading response box is utilized by the system to qualitatively score a user's interaction with the content. For example, a particular sentiment meta-type may be associated with passive participation rather than active participation. The aggregate response data associated with each sentiment can then determine how the system gauges the user's learning capabilities and progress while reviewing a particular selection of content or over a particular time period based on responses to various selections of content over time. Referring now to FIG. 7C, the response box 745 of FIG. 7A is shown toggled to the theme annotations tab 755. Similar to FIG. 7A, the user is provided with a selection classes 715 to which the annotation will be associated. Additionally, the user is provided with a selection of theme sets 750, each of which provide various different themes associated with a specific subject matter such as the environment, corporate strategy, implementation, etc. The theme 760 displayed in the response box 745 can change each time a different theme set 750 is selected.

The user can be provided with a “yes” or “no” input provided in a column 765 alongside the themes for selection of each individual theme for that passage in a specific theme set 750. If the “yes” button changes color, shade, or appearance in any way, this can indicate a “no” selection. In some embodiments, these buttons can act as basic toggle buttons, click once it is “on” indicating a “yes” or “no” response and two clicks it is “off” removing the prior response. The buttons can be initially in the “off” position. Once the student makes a selection of one or more themes for that passage, e.g., through selecting “yes”, the user can input that theme selection for the annotation to that selected passage of content displayed.

Referring now to FIG. 7D, once a piece of content has been annotated, the selected passages for which an annotation has been made can be displayed with a darker shade or different color of quotations 775 around that annotated passage. The student can then select that passage again, with an input device such as a mouse or keyboard or touchscreen, or can click on the quotations to call the response box. The user can call the response box 745 to read other sentiments and/or themes identified in the quotations, or, to add their own annotation to the quoted passage.

The response box 745 is similar to the aforementioned response box 745 in FIGS. 7A-7C, including the sentiments 735, free form sentiment text box 725, sentiment preview 720, class selection 715 and input buttons 740. However, an additional section 780 of the response box displays other users previous annotations, in the form of predefined sentiments, to the same selected passage of content. Each user can be identified with the sentiment with which he/she annotated the passage and a time can be provided indicating when that user annotated the passage. The most recent annotations can be displayed in the additional section 780 of the response box. This can provide the user with an indication of when other users read the content, e.g., such as an assigned reading for a specific class, as well as spur discussion if that user disagrees with a particular sentiment expressed.

The user can choose just to view what other users feel about that passage and not add any particular sentiment or theme by selecting the “close” input button 740. Alternatively, if a user decides to add an additional annotation to the annotated passage, a similar process can be followed as described with reference to FIGS. 7A-7C.

FIG. 7E illustrates another embodiment of a response box 745 that is displayed on a previously annotated portion of content. Similar to the response box shown in FIG. 7B, the response box 745 in 7E provides additional, grouped sentiments based on an associated meta-type. The response box 745 also provides the user with a text box 725 to elaborate on a selected sentiment (e.g., “Really?”) within the response box 745. The response box 745 can be made visible to user through selection of the pencil icon 739. The prior responses, or annotations 720 and user providing those annotations to the portion of content are also shown in the response box to the user.

In FIG. 7F, an example screenshot of an entire selection of content as displayed to a user in the micro-reading response system is shown. The selection of content in FIG. 7F has already been viewed and annotated by several users in the system. Accordingly, the response data has been aggregated for that selection of content and can be visualized by the current user viewing that content. The content can be shown on one side of the display screen of a computing device while the response data and other metadata associated with that particular selection of content is displayed on the other side of the display screen. The user can toggle between viewing only the selection of content versus the content and response data through selection of a view button 783 provided by the system.

When the response data is shown in-line with the selection of content, particular portions which were previously selected and annotated can be underlined 781 or otherwise called out in the text displayed, such as in the case of content being read by a user. For example, when a user hovers over an annotated portion or passage of content, that portion can be highlighted 782 for the user. Each of the previously selected and annotated portions can also be color-coded, depending on the meta-type of the responses provided. If more than one meta-type of response is provided, the colors associated with each can be mixed together. For example, if a passage is equally annotated with sentiments associated with red and yellow, the underlining for that passage will appear orange. In an additional embodiment, the underlining for a particular passage that has been heavily annotated can increase in size or hue based on the number of annotations made to that passage. The heavier the underlining or the deeper the hue can indicate higher consensus of the meta-type associated with that passage. For example, this can aid in determining the passage should be brought up for discussion by a professor in a particular class as well as determining if a student is actually engaged with the content. For example, if a student is viewing the content in FIG. 7F and only selects and annotates the passages with the heaviest underlining and provides similar colored sentiment responses, that user may be not be engaged with the content and just following the other students' responses.

Still referring to FIG. 7F, the responses to the content can be indicated not only within the content itself, but also along the length of the content 787 as illustrated with tick marks 784, 786. Each tick mark can represent one or more responses, or annotations provided in response to a portion of (e.g., a passage or selection of text) the content at that point within the content. Similar to the underlining described previously, the tick marks can be color-coded to indicate which meta-type of sentiment is expressed at that point within the content. The colors of the tick marks may also be mixed dependent on the aggregated sentiments provided for that portion of content. The size, or width of the tick mark can also provide an indication of how many other users have provided micro-reading responses to that portion of content.

A user viewing the content may select any of the tick marks to display a pop-up box 791 for the micro-reading response associated with that tick mark. The box 791 displays the portion of content annotated along with the sentiment associated with that content 789, the user providing that response 789, and the course with which that user is associated 789. The box 791 also provides a color coded push pin 788 which may be associated with the meta-type for the sentiment provided in some embodiments. The push-pin 788 allows the user to keep the box 791 visible, for example, to allow the user to view multiple boxes along the content to see and compare other responses regarding that particular portion of content. The box 791 also provides a button 792 soliciting the user to further respond to the sentiment 789 indicated within that box 791.

Referring now to FIG. 7G, if a user chooses to add an annotation to an already annotated passage of content, the micro-reading response system can generate a “pop quiz” to solicit additional feedback from the user regarding that passage. This can be generated in the system when a particular passage has been annotated heavily by users within a specific class, when the predefined sentiments utilized to annotate a passage are controversial (e.g., “agree” versus “skeptical”), or when the system detects that a user may have annotated without reason (e.g., utilizing the same sentiment repeatedly on only previously annotated passages). The “pop quiz” can generate an additional input box 790 for the user to enter a free form comment to the question 795 generated regarding the passage 710.

In certain embodiments, the system can automatically generate the “pop quizzes” after a predetermined time period for each user, after a predetermined number of annotations are made by that user or based on the weighting of the user's profile and/or previous annotations. This is because the responses to the “pop quiz” can be included in a statistical report provided to, for example, the instructor of a specific class and can be utilized by that instructor to generate discussion in a classroom environment. The responses to the “pop quiz” questions can be submitted after text is entered into the free form text box 790 and can be sent to the instructor of the class on a daily or weekly basis for review. Additionally, the response may be used in the feeds of the student who had controversial annotations to the same passage to generate additional comments and/or discussion on that topic.

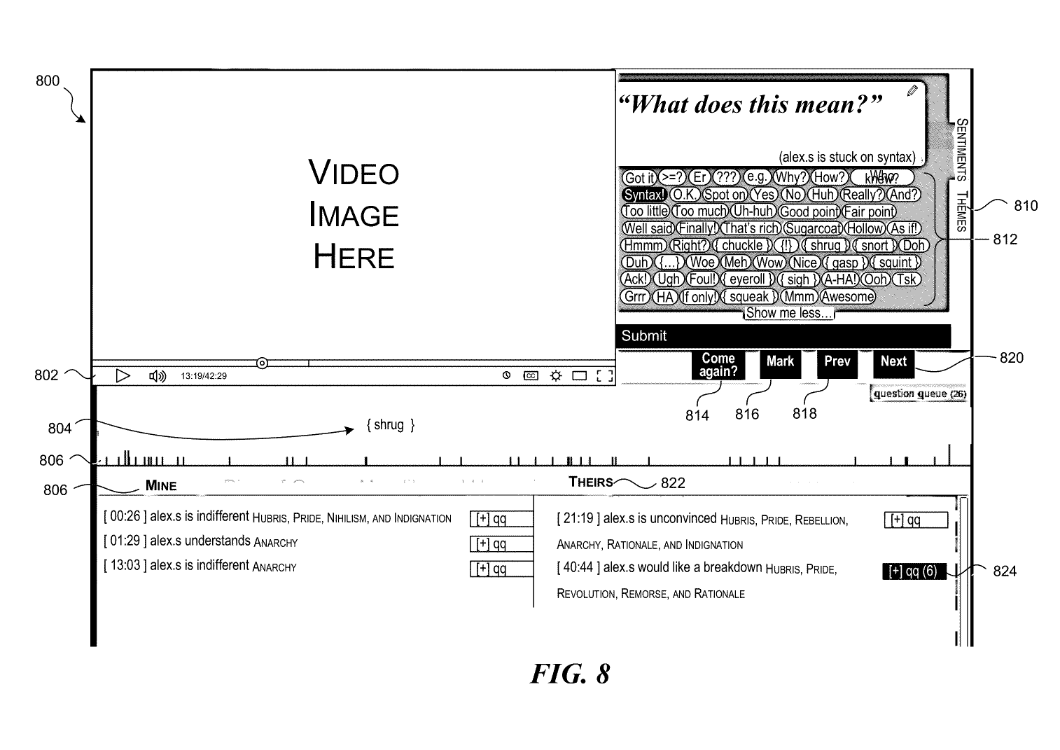

Next, FIG. 8 illustrates a screen shot 800 of micro-reading responses to video content viewed through the system. The video is displayed on a portion of the display screen of a computing device and includes the basic video controls 802 to play, stop, pause, and further adjust the video. Additionally, two sentiment feeds 808, 822 providing prior annotations to the video are provided. A user feed 808 can be associated with the particular user viewing the video content. The user feed 808 can provide a sequential listing of each annotation made by the user at a particular point within the length of the content. These annotations, along with those made by other students can also be shown via the actual sentiment selected 804 or as tick marks 806 along the length of the video content, similar to those shown in the selection of textual content illustrated in FIG. 7F. The tick marks can be color-coded to show the meta-type for the annotation made at that particular point in the video, similar to the color-coding described in FIG. 7F. The tick marks are clickable, taking the user to the appropriate point in the timeline of video to see what it was their classmates were reacting to.

A class feed 822 can provide a sequential listing of each annotation made to the video content by other users in the course for which the content is being viewed. The class feed 822 can indicate the point in time at which the annotation was made in the video content along with the name of the user who made the annotation. Each of the feeds 808, 822 can also provide a question queue button 824 correspond to each annotation in the feed. The question queue button 824 allows users to add a vote to add that particular response, or annotation into a question queue, e.g., for a professor to refer to in a particular class. Each of the listed annotations are clickable, and clicking them will take the user to the corresponding point on the timeline of the video.

Within the user interface displaying the video content, a response box can always be displayed for the user to quickly enter a sentiment 812 or theme 810, which will also appear in the user feed 808. The user is also provided added video playback controls to allow a student to easily rewind the video by five seconds 814, mark a particular point in the video (e.g., similar to bookmarking a page in a book) 816, and jump to a previous 818 or next 820 tick mark in the video. Additional details regarding the annotations made to content and how they appear in feeds is further described in the following section.

### VI. Feeds

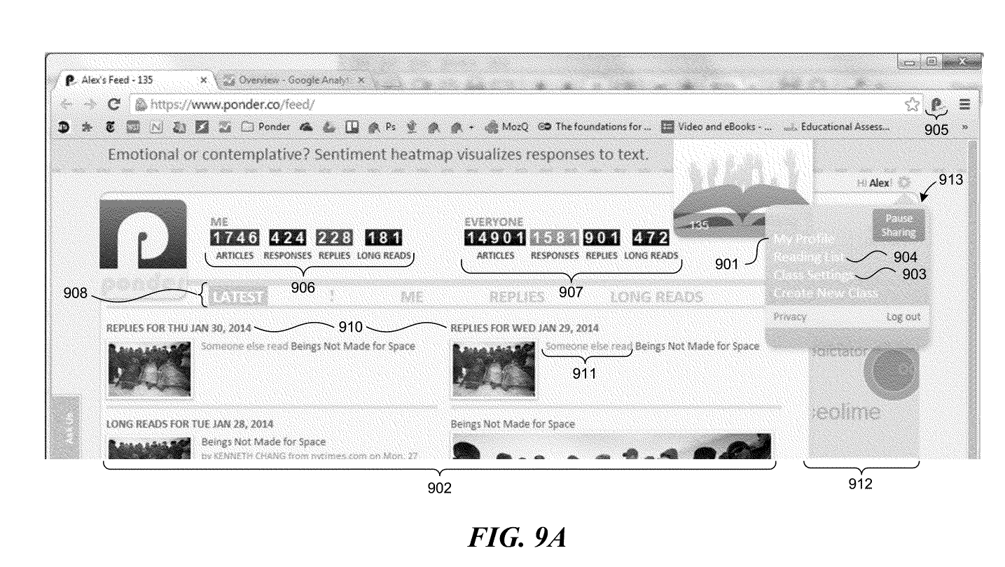

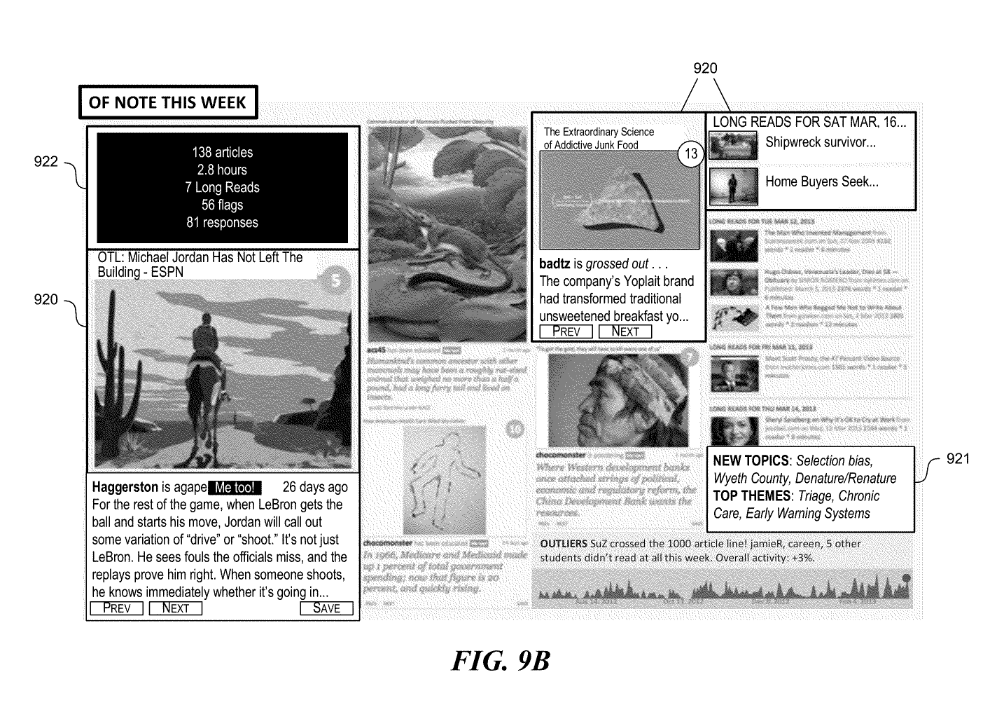

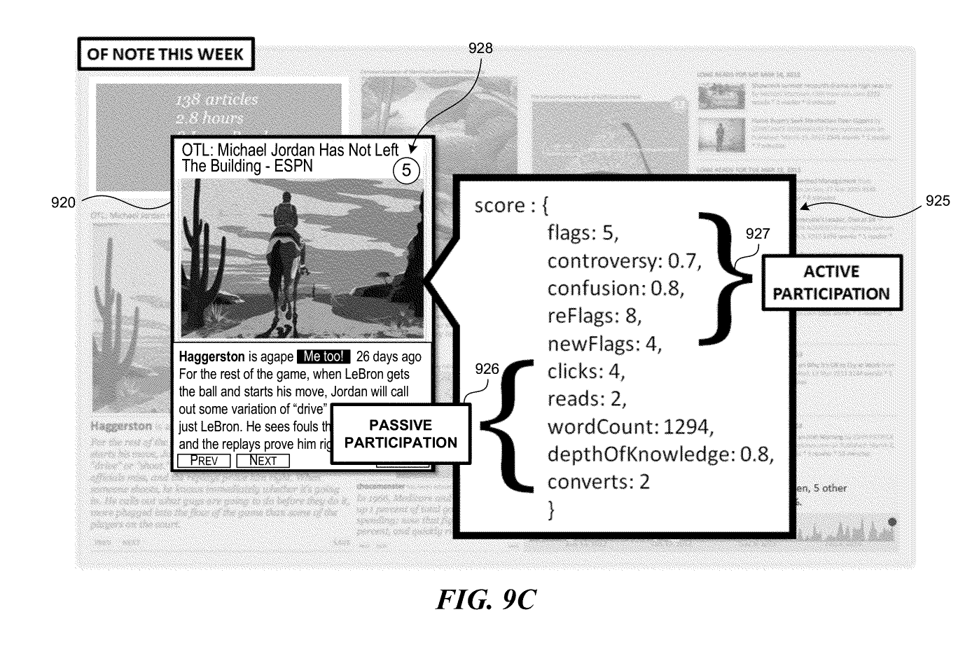

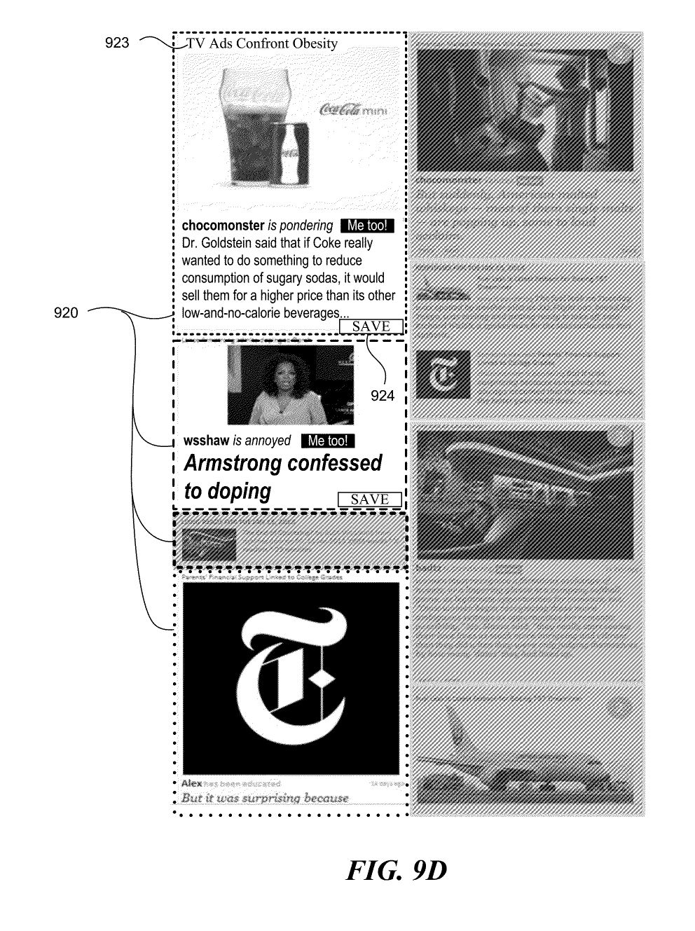

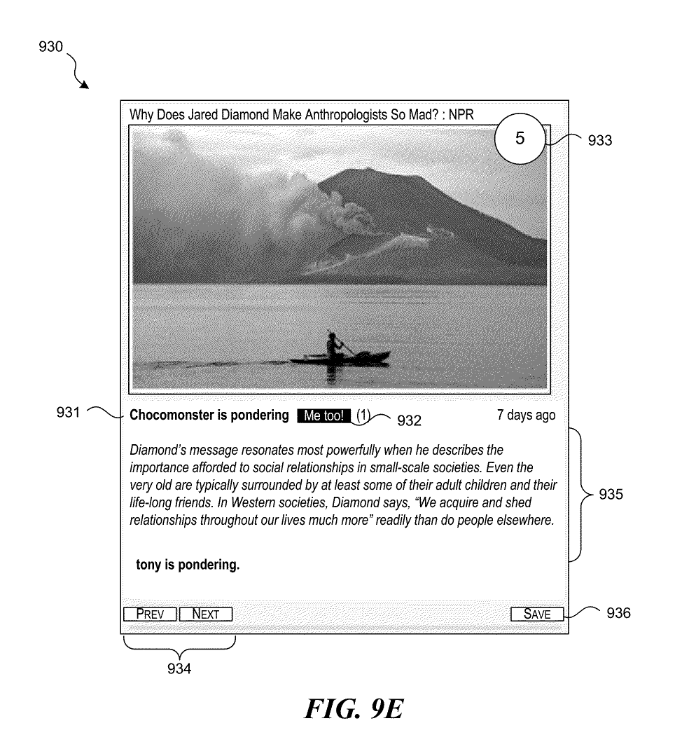

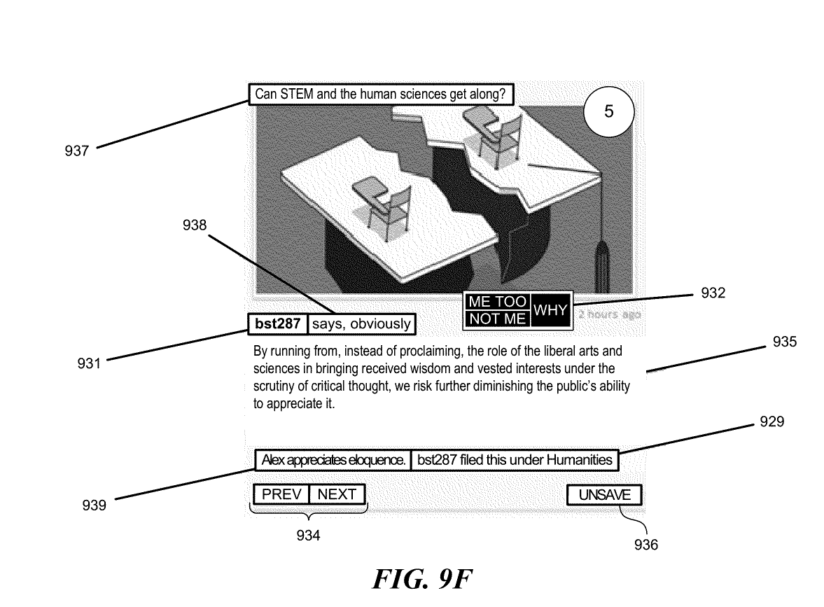

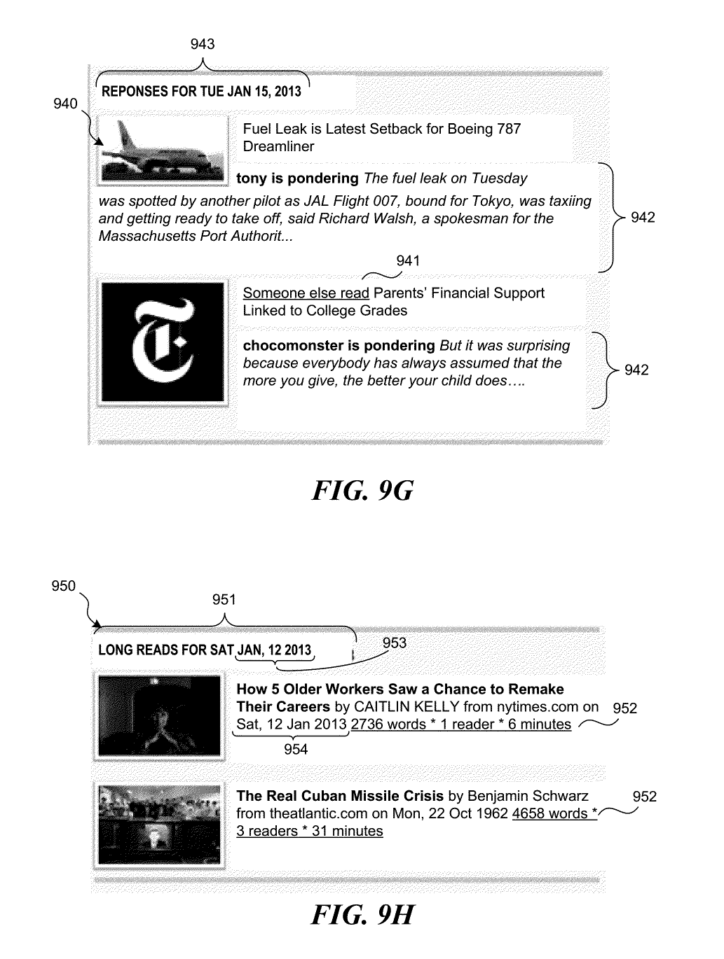

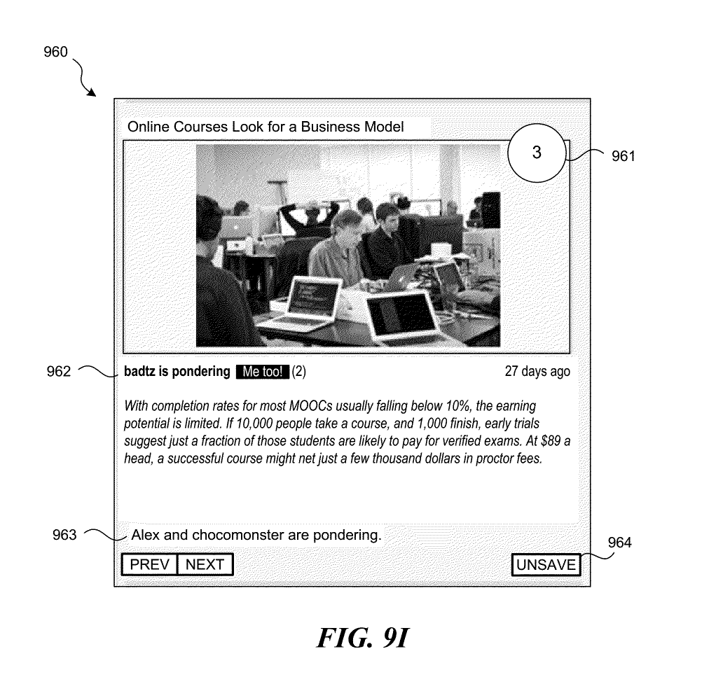

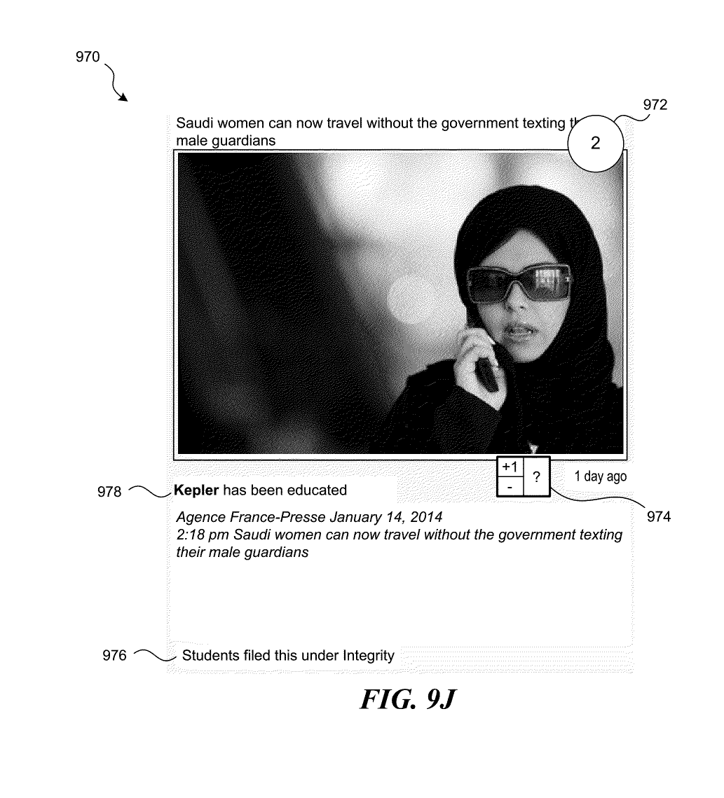

Various types of feeds and feed elements are now described with reference to FIGS. 9-15.

Referring now to FIG. 9A, an example of a “home” page 900 of a user is shown. The page can be accessed when a user is registered with the micro-reading response system and is running the client software application, such as a plugin, through a client device. The user can access the system through, for example, a symbol 905 appearing on the toolbar of a browser window.

On a user's profile or home page, the user is shown a particular feed 901 for a particular group of users, such as class in an educational environment. Different feeds can be visible to users registered with multiple classes in the system. The user can toggle through various class feeds by name through a drop down menu 901, which will modify the title and contents of the feed displayed to the user. The user can also toggle between viewing the class feed 902 or an instructor's class page 903 associated with that feed.

The user also has control over whether they wish content they read and annotate to be shared with other users in the system through selection of the “pause sharing” button. If a user chooses to pause sharing, the system no longer receives any inputs regarding the user's reading activity. While the client is paused, the reader is unable to annotate, nor will the client be pulling down other annotations and metadata to display on a given page of content. The user essentially selects a private browsing of content, even though the client software is being utilized. Accordingly, the micro-reading response system is no longer able to assess the user's level of engagement and level of understanding of the material being read while paused. Additionally, the statistics on that user's reading activity will not be included in the statistics visible to both the class and the instructor. Similarly, the instructor will no longer continue to have visibility to that user's annotations even thought that user has chosen not to share with other users. In some embodiments, the instructor can be notified if a user is only utilizing the system in a “pause sharing” mode so that the instructor can solicit the user to provide feedback for assessment.

The user can also access the reading list 904 for a particular class on their home page. This reading list can provide any required content by an instructor as well as any suggested content, such as journals or websites associated with particular subject matter for that class. In some embodiments, content read by a threshold number of users or number of weighted users in a particular group of users, e.g. a class, can cause the system to add that content to the reading list for other users in that class to easily access.

Still referring to FIG. 9A, a user is shown for any particular class a statistical summary of themselves 906 versus other users 907 in that class. The statistical summary can include the number of articles, e.g., content read, the number of annotations or responses made in the content read, the number of responses to the content read, and the number of long reads.

The user can also selectively filter the feed content on their home page to a specific type of nugget. A nugget can include a particular category of content. For example, a nugget can include content which is annotated, read content, content considered a long read (e.g., over a threshold word count and a certain amount of reading time by a user in the group), or content saved by the user. The nugget types are provided in a selection bar 908 across the top of the user's feed for a particular class and can be selected to display only data related those types of nuggets in the feed. For example, as shown in FIG. 9A, all type of nuggets are displayed in the feed. Each type of nugget is indicated in the heading 910 of that content within the feed. Accordingly, even if all types of nuggets are displayed, the user can still differentiate which type they are viewing.

The homepage of the user can additionally allow the user to access the statistics of themselves and other users within the class in a quick access column 912 viewable adjacent to the feed. Just as the feed may change each time that a new annotation is made or new content is read, the statistics change within the quick access column 912. The column 912 can provide the user with the most recent statistics on the class users amount of content read, the most popular content read, the most popular sites on which content is accessed and the most common topics or themes identified by the users in that class.

Referring now to FIG. 9B, a screenshot of a feed displayed on a home page of the user is illustrated. The feed includes various boxes of content within the feed which may provide points of interest to the user. The boxes of content are also referred to herein as nuggets. The nuggets can be selected for the user's feed based on the user's annotations to viewed content. Each nugget 920 can indicate a particular type of content viewed by the user as well as a quick visual indication of the number of other users who viewed the content, themes and/or annotations associated with the content and a selection of the content. Additionally, the feed can provide a summary 922 of the content viewed by that user. For example, a listing of the number of articles read by the user, the hours spent viewing the content by the user, annotations made by the user in the content viewed, and flags in response to annotations made by other users. A summary 921 of the themes associated with content viewed and new topics associated with the content viewed can also be displayed.

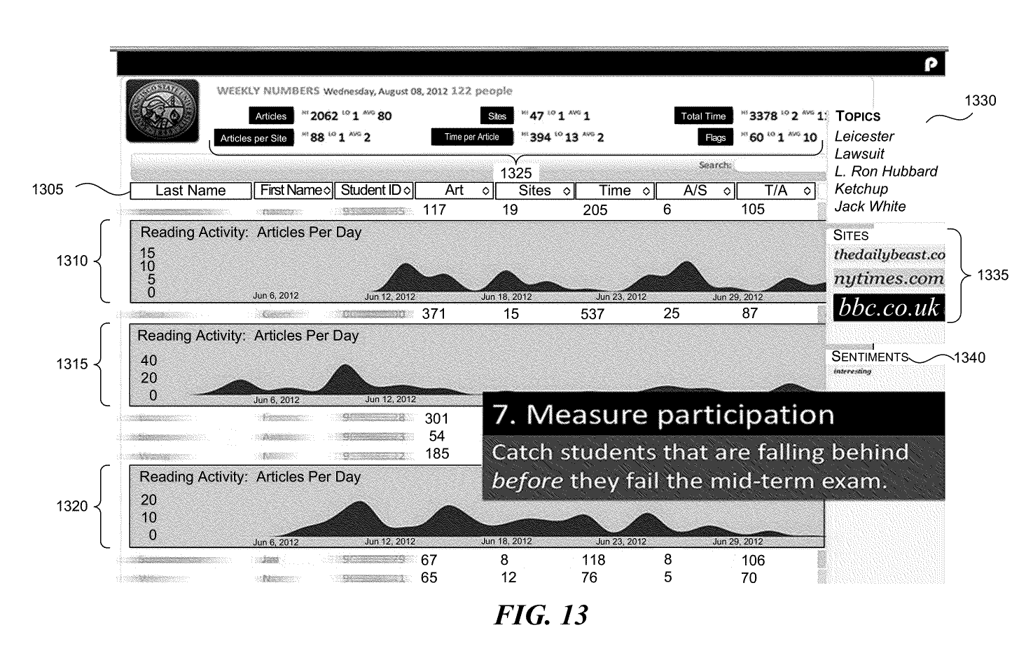

In FIG. 9C, the system analysis of response data 925 associated with a particular nugget within the feed of FIG. 9B is further described. As shown, the nugget has been annotated or flagged by five users 928. The scoring of the particular content is based on active participation 927 and passive participation 926. The type of participation can be determined based on the meta-type of sentiment provided by the users. Accordingly, when the system aggregates the response data for a particular selection of content, the graphical metrics later described within reference to FIG. 13 can be calculated according to the score associated with the response to that content. For example, as shown in the response data 925, a controversy and confusion score are provided. Each of these scores correspond to an assessment of the sentiments provided in response to the content as well as the metadata for the meta-type associated with those sentiments. The assessment provides a group-level score for that particular content. The assessment can include additional factors as well such as the length of the content.

FIG. 9D illustrates an example of a feed in which several types of nuggets 920 are displayed. Each nugget can be identified through the title 923 associated with that nugget. As shown, various different types of nuggets in the feed are visually distinguishable as some provide annotations and allow commenting while other only provide a summary of the content read. The user is also given the option to “save” a nugget in the feed. The save feature adds a saved tag for a given nugget, for a specific user, that allows the user to retrieve that nugget in a smaller list on their feed. Accordingly, selection of the save option also saves the particular nugget in the “saved” feed, which is selectable for viewing on the user's homepage.

The feed, or activity feed, is populated by a custom assembly and custom sort order of the nuggets. Each of the nuggets is user-specific, dependent on the user's interests, such as defined through the content commonly read and annotated by that user, as well as the weighting of that user's annotations and selection of content based on, for example, the user's interest. Which nuggets are shown within the feed is dependent on the content which is recommended to the user based on the aggregated data analyzed in the recommendations module of the micro-reading response system.

Referring now to FIG. 9E, an example of an article nugget 930 is provided. The article nugget can be provided in a user's feed if that user has read/annotated the content of that article while reading it. Additionally, nuggets can be included in a user's feed even if that user has not read or annotated the content associated with that nugget. The micro-reading response system utilizes each user's profile (e.g., record of prior reading, annotations, activity, etc.) to determine which nuggets are included in order to improve the user's reading skills and expand the user's interest to other topic areas. The article nugget displays the first annotator's “chocomonster” 931 sentiment as well as an additional quick annotation button “me too” 932 that allows users having that article within their feed agree with the first annotator's feeling. The article nugget 930 can include the annotated passage 935 from the content as well as other annotator's sentiments following the passage. The user can toggle 934 through the sentiments expressed on that document and can save that nugget, e.g., for later discussion or viewing of later annotations made, to their saved feed. The article nugget also provides an indication 933 of the number of users who have annotated on the particular passage provided in the nugget.

FIG. 9F illustrates another embodiment of an article nugget similar to the nugget shown in FIG. 9E. As shown, the article nugget in FIG. 9F includes the annotated passage 935, the content title 937, the first user to annotate the passage and corresponding sentiment selected 938, along with additional sentiments (e.g., a second user to annotate the passage) 939 and themes 929 added by other users for the passage in the content. The nugget allows the user to skip to the next nugget or previous nugget via previous and next buttons 934 as well. The user can additionally choose to save 936 the nugget to his or her personal feed for later viewing. Additionally, the user can choose to remove the flagging of the nugget by selecting the “x” 944 button proximate to the save 936 button. The delete flag button 944 may only be visible to the users having permissions to delete the flagged article such as an administrator (e.g., teacher) for the group for which the content was created (i.e., flagged) or if you are otherwise the creator of the flag for the content. In the embodiment shown in FIG. 9F, the user is additionally provided with a selection of buttons 932 to respond to the sentiment expressed by first user to annotate the passage of content. For example, the user can choose to agree (“Me too”) with the sentiment expressed, disagree or provide an additional response (“Why?”), e.g., free form or sentiment, to the first user's sentiment 938. When the user selects the “Why?” the response box can be displayed, similar to when a user is viewing a selection of content.

Referring now to FIG. 9G, an example of a response nugget 940 is shown for two stories which the user has read and for which other activity, e.g., other users have read and/or annotated, in the micro-reading response system. The response nugget 940 provides an indication of the nugget type and the date for that nugget in the title 943 of the nugget. Additionally, if any annotation has been made on a particular passage from the content of the story, a portion of the text 942 is provided along with the annotating user's sentiment. A user who only reads the document that has been annotated, but does not re-annotate it, has their privacy preserved, and the reply for that read is described anonymously 941, though additional information on that user or any annotations to the story is provided.

Referring now to FIG. 9H, an example of a long read nugget 950 is provided which is shown in a class feed. A long read is, for example, when a large number of users all spend a lot of time reading a long article, it is called a long read and the system then provides that article to other users as recommended content. Accordingly, if a user is reading content specific subject matter and a long read is known in that system about that subject matter, the system can add that to the user's feed based on the fact that numerous other users in a class have read or are reading it. The system also knows when a user has not read a long read, such that it can also be recommended after a certain number of associated users have read it. The long read nugget 950 can include a title 951 indicating that type of nugget along with the date 953 on which that long read was last read by the user and the date 954 on which the article was published. The long read nugget can also give content statistics 952, such as the word count, amount of users who have read the long read and the approximate time period for user to read the long read.

Referring now to FIG. 9I, an example of a saved nugget 960 is shown. The saved nugget can include any type of content and/or nugget, including annotators 962, the number of annotations 961 and sentiments 963. The only visible difference in a saved nugget and a nugget in the user's feed is that the “save” button is toggled to “unsave” 964, which allows a user to remove that nugget from the user's saved feed. The nuggets that are saved by a user can be used by the system to weight a user's interest in certain topics or fields of interest, similar to the number of annotations that user makes on content pertaining to certain topics or subject matter and/or the amount of content, e.g., the number of articles, read about those topics. In some embodiments, the user is permitted to save as many nuggets as desired in his or her user feed for an unlimited time period. In certain embodiments, the user is only allowed to save a specified number of nuggets in that user's saved feed. In other embodiments, saved nuggets are removed from a user's saved feed after a predetermined time period.

FIG. 9J illustrates an additional embodiment of a nugget including a peer review component. The nugget 970 includes an indication 972 of the number of users who have annotated the content displayed in that nugget as well as the first user 978 to annotate the content and corresponding annotation. The nugget also provides an indication of a particular theme 976 associated with content. The peer review portion includes multiple boxes 974 in which a user viewing the nugget may additionally respond to the content and annotations viewable in the nugget. The boxes provide a “one-click” input response to the nugget to show agreement (e.g., “+”) with the content, disagreement (e.g., “−”) with the content, or provide a further response to the content (e.g. “?”). Each click of the “+” and “−” buttons increments the count for the students in agreement, e.g., +2, with the annotation, or in disagreement, e.g., −3, with the annotations. When the user viewing the content chooses to provide a further response, the response box including the predetermined set of sentiments corresponding to the content can appear. Accordingly, the user is able to view the two prior responses 972 to the content as well as enter his or her own response via selection of a sentiment and/or entry of free form text. In some embodiments, when the user chooses to respond to a nugget, the original selection of content, e.g., the article in its entirety is displayed to the user. When a user annotates or saves a particular nugget to a user feed, the metadata associated with that content and, in some instances, a portion of that content, can be utilized to provide a visual representation of the topics associated with content viewed by the user in a user-specific topic clouds.

Referring now to FIG. 10A, an example of a screenshot of a topic cloud provided for a class associated with a user is shown. The topic cloud can be provided to summarize popular topics 1010 read by users in a group, such as a class, over a predetermined time period. The topic cloud can additionally include an asterisk (“*”) indicating which topics were covered in the content viewed by the user. The topic cloud provides a medium through which the user can visualize the amount of content being read across the class in each topic as well as the content which the user has read, indicated by an asterisk by that specific topic. The larger the font of the topic in the topic cloud, indicates the more content read, e.g., articles read, websites visited, time spent, annotations created, on that topic. if a user selects a specific topic in the topic cloud, the topic expands to provide the most commonly read content 1005 in that topic area to the user. The user can then read similar content to the other users in the class.

The topic cloud can provide a good indication to the user that the user is, for example, understanding a specific theme in a class. If the user is reading only the most uncommon topics, e.g., the smallest font and/or not on the topic cloud page, this provides a good indication that the user will be unprepared for any future discussions in a classroom environment as those topics were visited by the majority of other users in the class. Additionally, the topic cloud can allow the micro-reading response system to weight specific topics and subjects more heavily for recommended reading to a user. As in the aforementioned example, if a user is struggling to identify the necessary topics to read for a specific class and is failing to read the most read content, the micro-reading response system can populate the user's feed with the more pertinent articles in order for the user to read them. Additionally, the topic cloud can be reviewed by an instructor of a class or suggested to the instructor in system generated report on which topic areas are most popular in a class for future discussion.

Referring now to FIG. 10B, an example of a screenshot of the course concepts cloud indicating the course concepts annotated in the content read by the user and other users in the class. The course concepts can include, for example, themes indicated by the instructor of a class during configuration of the class paged, including the recommended reading and users associated with the class. Similar to FIG. 10A, the course concept cloud provides the keywords 1025 for the themes and in a larger font 1015, dependent on the number of users identifying that theme, e.g., through annotations in the content read. If the user selects one of the concepts, content such as articles 1020 in which that theme was annotated by other users or that user is provided for reading. Additionally, the asterisk next to a theme indicates that the user has annotated that content with that theme.

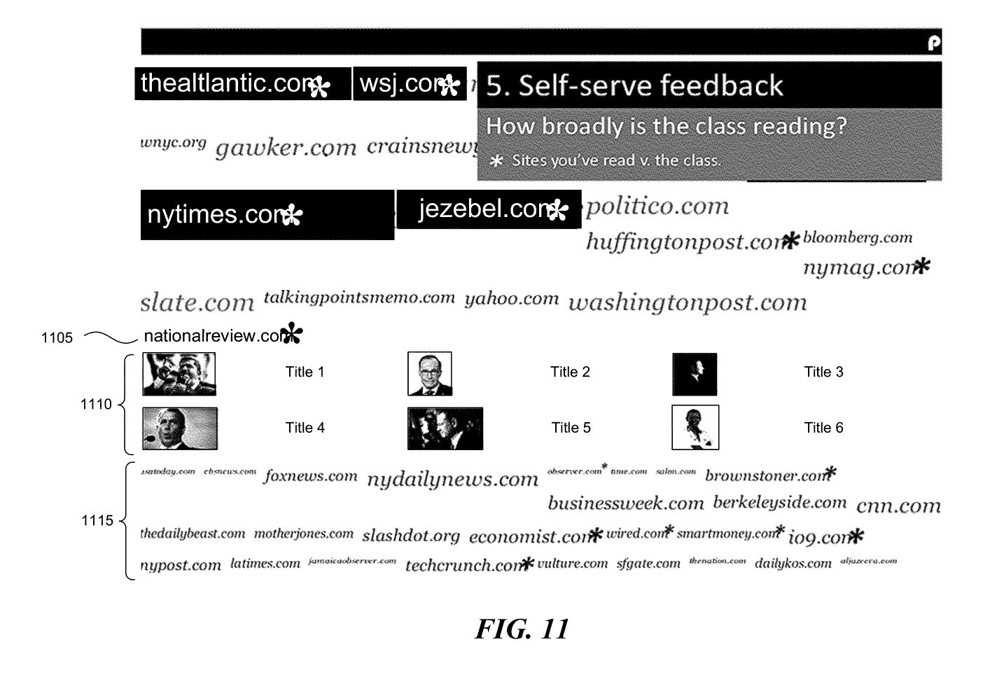

Referring now to FIG. 11, an example of a screenshot of content provider cloud, such as websites visited, for a class associated with a user is shown. The websites visited by the class summarize popular websites visited by users in a group, such as a class, to read content. The content provider or site cloud provides a medium through which the user can visualize the most commonly visited websites by the users in the class 1115 as well as the websites which the user has visited 1105, indicated by an asterisk. The larger the font of the website in the cloud, indicates the more visits and/or content read on that website. If a user selects a specific website in the cloud, the website expands to provide the most commonly read content 1110 on that website. The user can then read similar content to the other users in the class.

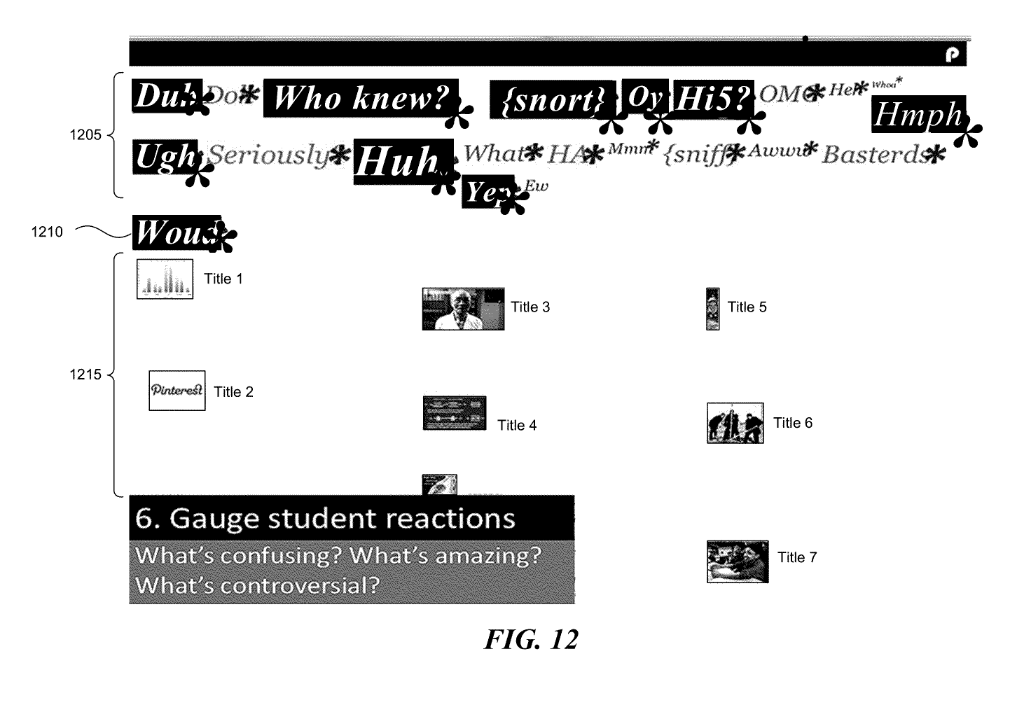

Referring now to FIG. 12, an example of a screenshot of a sentiment cloud indicating the sentiments 1205 most annotated in the content read by the user and other users in the class. The sentiments can include the predefined sentiments selected from the micro-reading response box shown in FIG. 7A-7G. The sentiments most commonly annotated in the content read by the class are provided in larger font. The sentiments 1210 annotated by the user are shown with an asterisk. If the user selects one of the sentiments, whether utilized by the user or not during annotation, content 1215 such as articles in which that sentiment was annotated by other users or that user is provided for reading.

Referring now to FIG. 13, an example of a screenshot of a summary of the statistics for the qualitative measurements for each student calculated by the micro-reading response system for a specific group of users, such as a class. While the instructor can view all data shown in FIG. 13, each user may be provided with some visibility as to the content read by other users, the annotations made and website visited by other users. On the home page of a user, the user is also provided with the summary of the annotations made to content, content read and time spent reading the content.

FIG. 13 provides a more extensive summary 1325 of the statistics provided in the feeds to each individual users as well as visual metrics 1310, 1315, 1320 for each student in an entire class over the course of the semester, for example. The summary 1325 may only be visible to the instructor for all users in the class, while users may only be provided with a similar, extensive summary of themselves. The instructor of a class can utilize this summarized report of metrics to see how a user's reading activity has progressed over the course of the semester by selecting that user from a drop down menu bar 1305. The instructor can also compare several users over the semester to determine, for example, times when the highest level of engagement occurred. The instructor can determine how much time is being spent on specific materials types.

Additionally, the instructor can view the activity clouds 1330, 1335, 1340 specific to each user when that user is selected on the visual metric. For example, the instructor can see each students sentiments used during annotations, websites visited by that user, and topics annotated by the user during reading. This provides the instructor with some context as to if the user is following the class and understanding the material on an individual basis. Accordingly, the instructor can determine if a user requires additional help or attention.

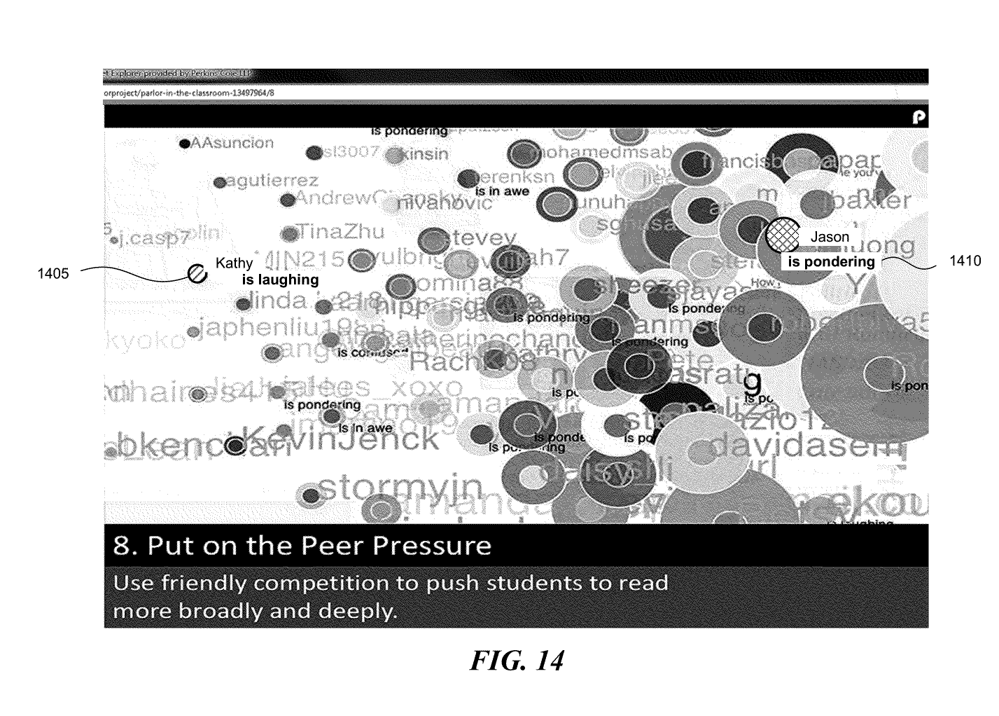

Referring now to FIG. 14, an example of a screenshot of a visual metric visible to each user in a class is shown. Each circle set indicates a user in the class, also indicated by the name of that user next to the circle set. The location of the circle set indicates an aggregation of the depth and breadth of that user's reading activity. The farther right on the horizontal axis shows a broader range of reading content covered by the user. The lower down on the vertical axis indicates a longer amount of time (more depth) spent on a specific content. The farther up on the vertical axis indicates the least amount of content read and the least amount of time spent reading. Accordingly, each user can determine how they place among other users in the class.

The circle set 1405 also provides additional characteristics on the each user's reading activity. The inner circle on the circle set indicates the amount of content, e.g., number of articles read, by a particular user, while the outer circle or ring represents the amount of time spent reading by that user. The brightness of the circle set indicates how recently that user was active on the micro-reading response system. The sentiment 1410 most recently annotated by that user can also be shown next to a user's circle set.

### VII. Additional Embodiments

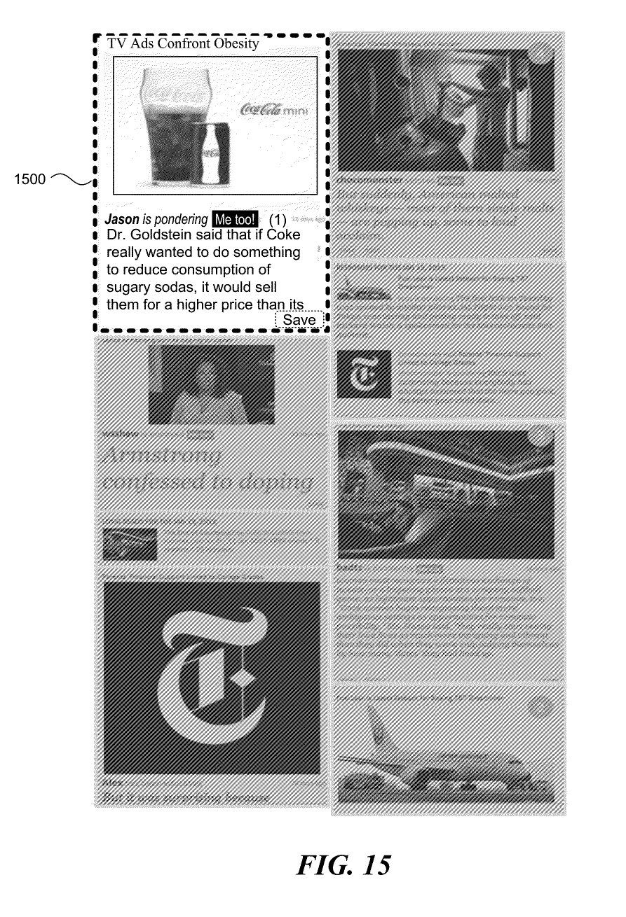

FIGS. 15-19 illustrate additional embodiments which are implemented by the micro-reading response system.

Referring now to FIG. 15, an example of a screenshot of a nugget in a feed is provided. As the volume of annotations increases in a specific class, due to users participating more (increased reading activity in the system), the system can begin to selectively decide when to deliver annotations to a user. As provided in FIG. 15, a nugget having an annotation which is considered to be under implicit peer review is shown. The nugget appears with only a single annotation and can be distributed to a profile-diverse group of users in the class to gauge their reaction and, essentially, provide a score for that annotation. For example, the users reactions can be to annotate the nugget, skip the nugget, read the entire article provided in the nugget or create a new annotation on content from the same article.

The micro-reading response system can record data about which users view the annotation in order to determine if the annotation meets a specified threshold of user engagement in order to be distributed to all the users in a class. Additionally, if the annotation meets such a threshold, the user providing that annotation can be weighted differently than a user whose annotations are never viewed. This qualitative measurement can be provided to the instructor of a class in order for the instructor to determine which students are understand the material and raising valid points within it and which students are struggling with the material. Additionally, good annotations are distributed to the users in a class as suitable types of annotations which can be accepted.

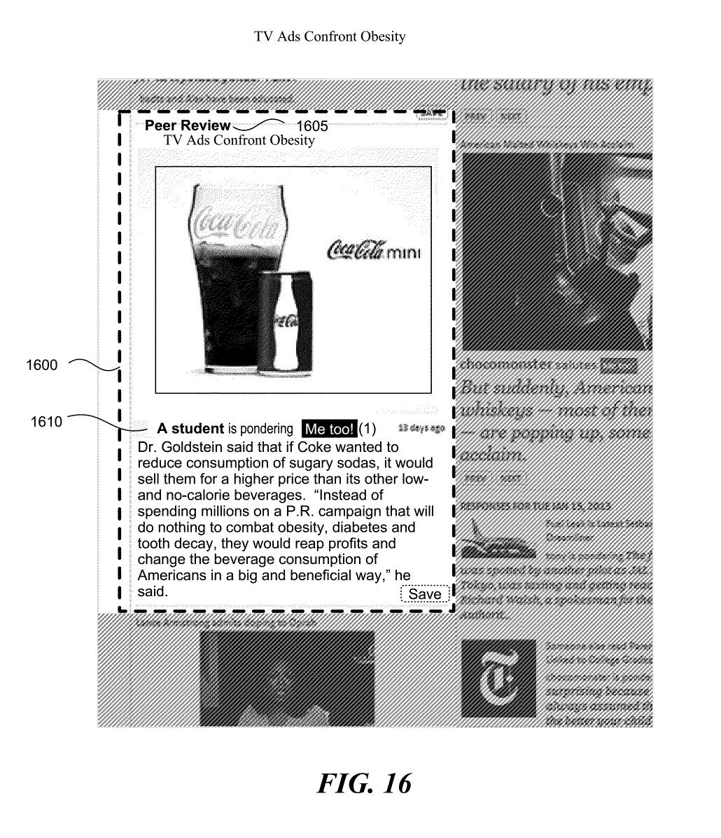

Referring now to FIG. 16, an example of a screenshot of a nugget under explicit peer review is shown. The primary difference between an annotation under explicit peer review and implicit peer review (FIG. 15), is that the user reading that nugget is aware of the peer review process. The peer review is noted in the title 1605 of the nugget. Additionally, an explicit peer review does not provide the name 1610 of the user under review. Providing this anonymity to the user under review, can allow classmates to provide a more useful response to that user's annotation.

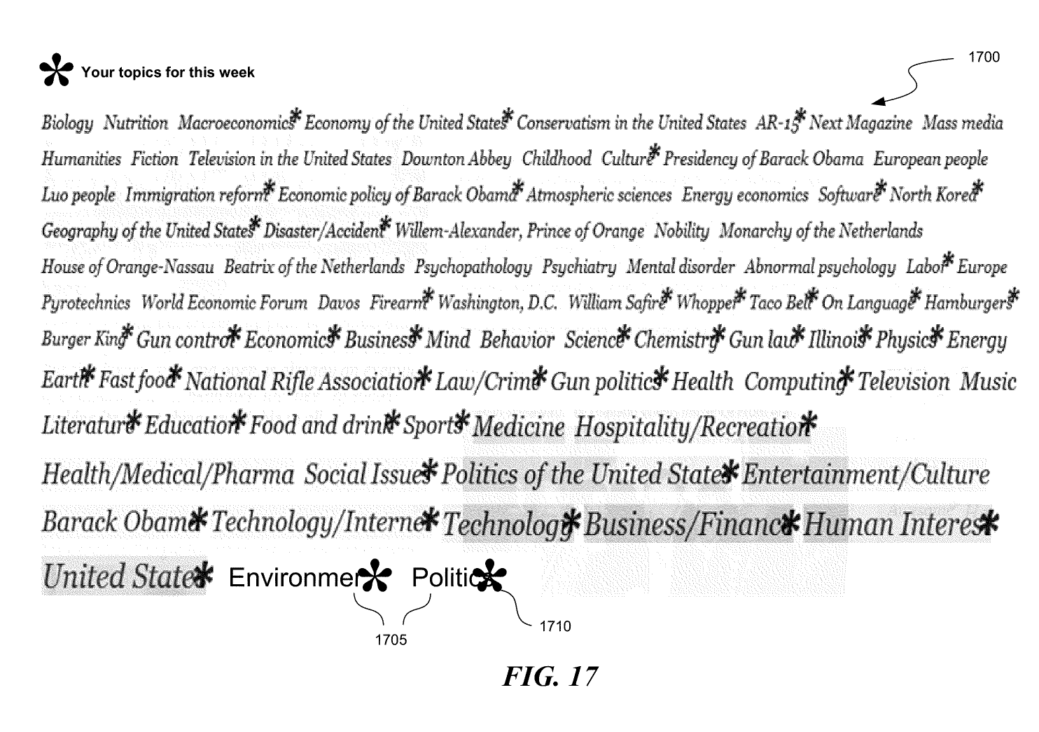

Referring now to FIG. 17, an example of a screenshot of a user's topic cloud 1700 is shown. The topic cloud can indicate all of the topics covered in content read by the user over predetermined time periods, such as a week. The topic cloud 1700 can indicate which topics were read about the most by the size of the font identifying that topic.

The user's topic cloud can define the user's profile through a set of topics 1705 that are selected from the topics most read, indicated by asterisk 1710, by the user. Additionally, the subject matter, depth (length of content combined with reader dwell time), source and target market of that source, source tone (e.g., Academic, investigative, opinion, gossip), sentiment analysis, micro-reading response activity, and theme usage can provide inputs for a topic pair selected for a particular user.

To assemble a profile for each reader, the system gathers all the data available for a particular user. As far as topic data goes, for the reading the user has viewed, the system knows what the most central topics for each of that user's readings are and the quality of their engagement with each of those readings (including variants in time, quantity and quality of sentiments and themes, etc.).

For one example user, they have engaged heavily with various articles. One article may be about politics. Another article may be about the environment. Another article may be about politics as relates to the environment. Another article may be about the lumber industry and its impact on the environment. Another article may be about the energy industry and the impact of the new natural gas “fracking” process. Another article may be about water polo. Based on the above example, the system determines which topic areas the user has “high credibility” (at least relative to other students in their class with other interests) in.

Content topic extraction provides a list of topics extracted from the articles based simply on the text of the articles: Environment, Energy, Policy and Water Polo. The micro-reading response system combines those simple extracted topic outputs with the reading engagement and activity data collected for that user, and the overlap where certain articles contain two seemingly separate topic areas 1705 like “policy” and “environment” into a new hybrid paired topic “environment-politics” as shown in FIG. 17. These two topics are combined to create a more nuanced profile of the user that can distinguish that user's topic area interests more distinctly from other users. Also, the combined topic pair allows the system to combine a user's engagement with each of a string of articles into a combined cross-article interest in the overlap between the two topics.

The user then has a “high[er]credibility” in the topic area of “environmental policy” than other students. That same user may have a lower credibility in water polo, where they seem to have taken interest in a single article. However, as far as the system can determine, the student has just not spent a lot of time reading and thinking about it.

The user's future annotations in articles about environmental policy will then be weighted as more of an “expert” contribution than their future annotations about water polo (should they continue to read/annotate about water polo). Over time, though, that student may develop an interest in water polo, and their profile would evolve to incorporate that new high credibility area.

Peer reviewing, as previously discussed, can also be weighted differently. For example, nuggets ready to be peer-reviewed are delivered to high and low credibility users for the topic pair to gauge relative interest in that topic. Nuggets with a clear bias for high or low credibility readers are distributed as either good introductory annotation to a topic or more expert appropriate.

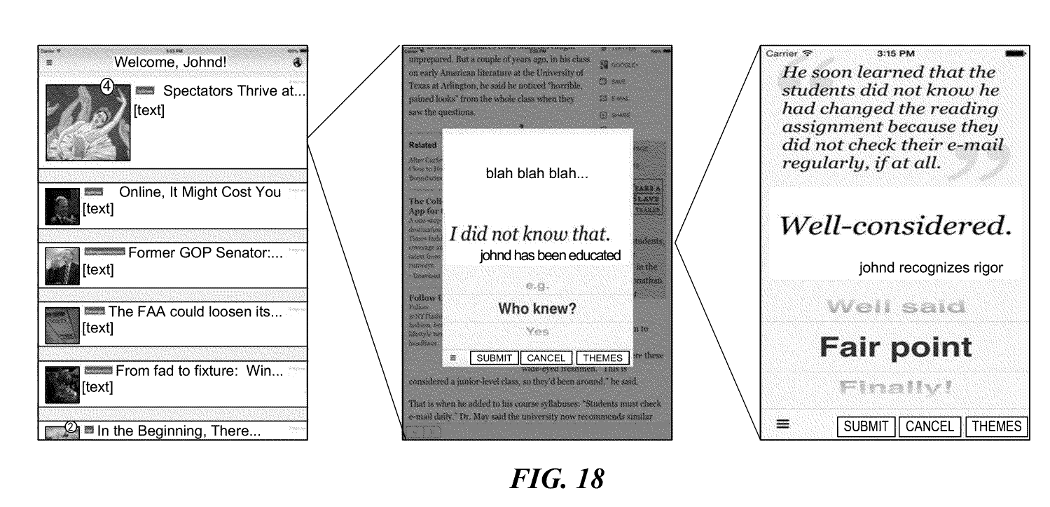

Referring now to FIG. 18, an example of a screenshot of a user interface on a mobile device, such as a tablet computer, is shown. The screenshot provides a user's homepage activity feed for long reads. This differs from the compilation of nuggets, including other nugget types, in the user's homepage activity feed in FIG. 8A. Due to the smaller screen size of the mobile device, the client software can provide the user with a different user interface which only displays selects items for easier viewing.

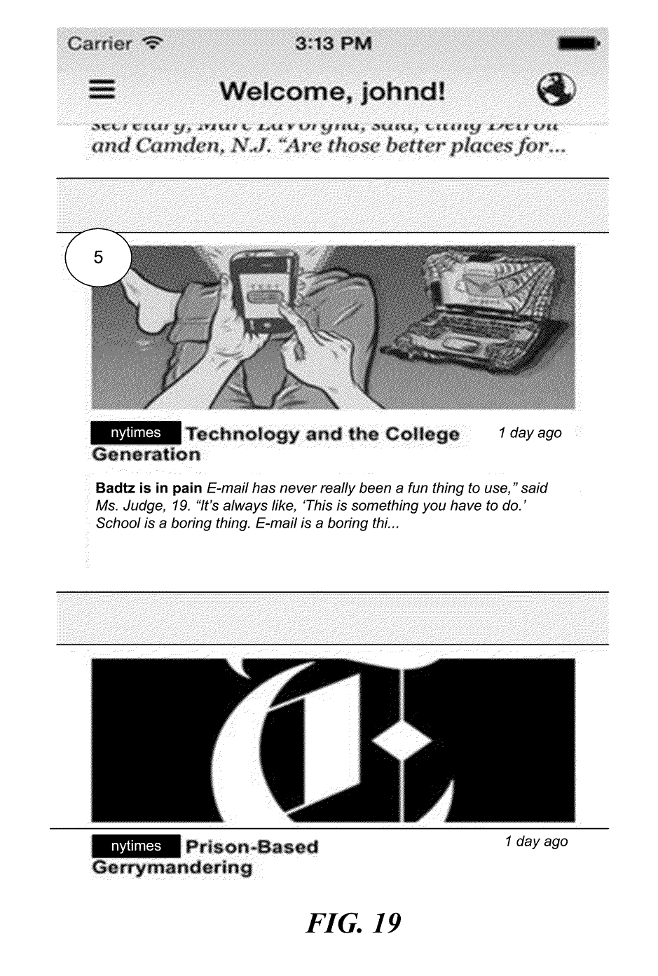

Referring now to FIG. 19, an example of a screenshot of a user interface on a mobile device for a user's flagged, or annotated, nuggets is shown.

### CONCLUSION

Those skilled in the art will appreciate that the actual implementation of a data storage area may take a variety of forms, and the phrase “data storage area” is used herein in the generic sense to refer to any area that allows data to be stored in a structured and accessible fashion using such applications or constructs as databases, tables, linked lists, arrays, and so on. Those skilled in the art will further appreciate that the depicted flow charts may be altered in a variety of ways. For example, the order of the blocks may be rearranged, blocks may be performed in parallel, blocks may be omitted, or other blocks may be included.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more content elements; the coupling or connection between the content elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The content elements and acts of the various examples described above can be combined to provide further implementations of the invention. Some alternative implementations of the invention may include not only additional elements to those implementations noted above, but also may include fewer elements.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to pursue additional claims after filing this application to pursue such additional claim forms, in either this application or in a continuing application.

I/we claim:

1. A method for quantifying interactions with content viewed by a user, the method comprising:
displaying, on a computing device, a selection of content to a set of users; storing activity data associated with the selection of content and associated with the set of the users;
receiving response data from each user corresponding to the selection of content, wherein the response data includes at least one sentiment, and
wherein a sentiment is a predetermined word or phrase describing a reaction to the content by a user;
aggregating the response data based on one or more criteria;
annotating the selection of content based on the aggregated response data; and
rendering the annotations onto the displayed selection of content.

2. The method of claim 1, wherein the selection of content is associated with at least one predetermined theme, and wherein the response data includes at least one theme corresponding to the at least one predetermined theme.

3. The method of claim 1, further comprising: associating the received response data with a location in the selection of content, wherein the location is indicated by a user providing the response data.

4. The method of claim 3, wherein the criteria include the associated location of the response data, and wherein the annotations are rendered at the associated location within the selection of content.

5. The method of claim 3, further comprising: generating a response window on the displayed selection of content, wherein the response window includes multiple sentiments for selection by each user, and wherein the response window is generated based on receiving the location indication from the user.

6. The method of claim 5, wherein each of the multiple sentiments is associated with a meta-type, wherein each meta-type includes metadata associated with a particular type of response to the selection of content, and wherein the criteria include a meta-type of the sentiment.

7. The method of claim 6, wherein the annotations are rendered corresponding to the associated meta-type.

8. The method of claim 1, wherein criteria include a group of users associated with the selection of content.

9. The method of claim 1, wherein the criteria include a language of the selection of content.

10. The method of claim 1, wherein the criteria include a particular level of knowledge associated with the selection of content.

11. The method of claim 1, wherein the content includes any one or more of video, audio, and text.

12. A computer-readable medium, excluding transitory propagating signals, storing instructions that, when executed by at least one computing device, cause the computing device to perform operations for assessing user activity in a learning environment, comprising:
storing activity data associated with a selection of content and associated with a set of the users;
receiving annotation data from each user corresponding to the selection of content, wherein the annotation data includes at least one sentiment, and
wherein a sentiment is a predetermined word or phrase describing a response to the content by the user;
aggregating the annotation data based on one or more criteria;
marking the selection of content based on the aggregated annotation data; and
rendering the annotation data onto the displayed selection of content.

13. The computer-readable medium of claim 12, wherein the selection of content is associated with at least one predetermined theme, and wherein the response data includes at least one theme corresponding to the at least one predetermined theme.

14. The computer-readable medium of claim 12, wherein the method further comprises: associating the received response data with a location in the selection of content, wherein the location is indicated by a user providing the response data.

15. The computer-readable medium of claim 14, wherein the criteria include the associated location of the response data, and wherein the annotations are rendered at the associated location within the selection of content

16. The computer-readable medium of claim 15, wherein each sentiment is associated with a meta-type, wherein each meta-type includes metadata associated with a particular type of response to the selection of content, and wherein the criteria include a meta-type of the sentiment.

17. The computer-readable medium of claim 16, wherein the annotations are rendered corresponding to the associated meta-type.

18. The computer-readable medium of claim 12, wherein the content includes any one or more of video, audio, and text.

19. A system for assessing user interactions in response to viewed content, the system comprising:
an interface for providing content for display to a set of users;
a data storage medium for storing data associated with the content and the user;
a processor for executing instructions stored on the data storage medium, wherein the instructions perform a process that includes:
receiving activity data associated with a selection of content displayed to a user in the set of users;
receiving response data from the user corresponding to the selection of content,
wherein the response data includes at least one sentiment from the user, and
wherein a sentiment is a predetermined word or phrase describing a reaction to the content by the user and,
rendering annotations onto the displayed selection of content,
wherein the annotations are based on an aggregation of the received response data from the user and other users in the set of users.

20. The system of claim 19, wherein the content includes any one or more of video, audio, and text.
